(19) United States
(12) Patent Application Publication
(10) Pub. No.: US 2026/0229572 A1
(43) Pub. Date: Aug. 6, 2026

(54) TETRA-COORDINATED BORONIC ACID-FUNCTIONALIZED POLYMERS

(71) Applicant: 1S1 Energy, Inc., Portola Valley, CA (US)

(72) Inventors: Sukanta Bhattacharyya, Belmont, CA (US); Daniel Sobek, Portola Valley, CA (US)

(21) Appl. No.: 19/155,008

(22) PCT Filed: Feb. 12, 2024
(86) PCT No.: PCT/US2024/015409

§ 371 Date: Aug. 8, 2025

Related U.S. Application Data
(60) Provisional application No. 63/444,772, filed on Feb. 10, 2023.
(60) Provisional application No. 63/624,533, filed on Jan. 24, 2024.

(51) Int. Cl. H01M 8/1039; C08J 5/22; C25B 9/23; C25B 11/048; C25B 13/08; H01M 4/90; H01M 8/10; H01M 8/1004

(52) U.S. Cl. CPC H01M 8/1039; C08J 5/2287; C08J 5/2293; C25B 9/23; C25B 11/048; C25B 13/08; H01M 4/9008; H01M 8/1004; C08J 2327/22; C08J 2365/00; C08J 2379/04; H01M 2008/1095

(57) ABSTRACT

A method of making a tetra-coordinated boronic acid-functionalized polymer molecule includes reacting a pendant boronic acid group of a boronic acid-functionalized polymer molecule with a fluoride reagent and/or a compound having the general formula HX, wherein HX is a Brønsted-Lowry acid. The tetra-coordinated boronic acid-functionalized polymer molecule includes a main chain and a tetra-coordinated boronic acid group linked to the main chain. The tetra-coordinated boronic acid group has the general formula —BFₘXₙ(OH)₍₃₋ₘ₋ₙ₎ where B has four covalent bonds and is covalently bonded to a polymer main chain, side chain, or side group; m and n are each independently 0, 1, 2, or 3; the sum of m+n is 1, 2, or 3; and X is an anion other than fluoride.

### RELATED APPLICATIONS

This application claims priority to U.S. Provisional Patent Application No. 63/444,772, filed Feb. 10, 2023, and U.S. Provisional Patent Application No. 63/624,533, filed Jan. 24, 2024, each of which is hereby incorporated by reference in its entirety.

### BACKGROUND INFORMATION

In electrochemical cells, such as hydrogen fuel cells and water electrolysis systems, proton exchange membranes (PEMs) are used to selectively transport protons. Proton exchange membranes (PEMs) are semipermeable membranes that transport protons (H⁺) while being impermeable to gases. PEMs are generally composed of a porous framework with highly acidic functional groups. For example, polyfluorosulfonic acid-based PEMs, such as Nafion™ (The Chemours Company, Wilmington, Delaware) and Aquivion® (Solvay SA Corporation, Brussels, Belgium)), contain a poly(tetrafluoroethylene) (PTFE) porous framework with pendant sulfonic acid side groups. The easily dissociable sulfonic acid groups serve as proton transport agents in the membrane. In hydrogen fuel cells, hydrogen gas (H₂) separates at the anode into protons (H⁺) and electrons. The protons pass through a PEM and combine with oxygen gas (O₂) at a cathode to produce water while the electrons flow through an external circuit to produce electricity. In water electrolysis systems, electricity splits water at the anode into oxygen gas (O₂) and protons (H⁺). The protons pass through the PEM and combine with electrons at the cathode to produce hydrogen gas (H₂).

A membrane electrode assembly (MEA) may include a PEM positioned between a first catalyst layer and a second catalyst layer. The catalyst layers are electrically conductive electrodes (anode and cathode) with embedded electrochemical catalysts such as metals, metal alloys, or metal oxides. The catalysts may be bound to a catalyst solid support, which generally are an electrically conductive, high surface-area carbon (e.g., graphite or graphene). The electrochemical catalysts reduce the activation energy needed to carry out the electrochemical reactions at the electrodes, such as the oxygen evolution reaction (OER) and the hydrogen evolution reaction (HER) in water electrolysis applications and the hydrogen oxidation reaction (HOR) and the oxygen reduction reaction (ORR) in fuel cell applications.

In some applications, the catalyst layer includes a supported catalyst mixed with an ionomer, an ion-conducting polymer. The ionomer binds the catalysts within the electrode, binds the catalyst layer on the PEM, and provides a pathway for cations (e.g., protons), thereby improving cation conductivity. In some MEAs, the catalyst layers are formed separately from the PEM and layered on the PEM in the MEA stack. In other MEAs, the catalyst layers are coated on the PEM to form catalyst-coated membranes (CCMs).

Water electrolysis and fuel cell applications involve strong oxidation and reduction chemistries under ambient to high temperature and acidic conditions. Therefore, PEMs and ionomers and the molecular functional groups therein responsible for proton transport properties should remain robust under the harsh reaction conditions of redox stress. However, conventional polymers used in PEMs and as ionomers, such as Nafion™ and Aquivion®, mostly contain sulfonic acid functional groups as proton transport agents. The sulfonic acid functional groups have only limited ability to withstand the redox stress from electrochemical operations, mainly due to the intrinsic physicochemical properties of sulfur. Furthermore, the sulfonic acid groups participate in secondary redox reactions promoting platinum group metal catalyst poisoning and de-polymerization of the polymer matrices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1A shows an illustrative reaction scheme for synthesis of a boronic acid-functionalized PBI polymer.

FIG. 1B shows an illustrative reaction scheme for synthesis of a boronic acid-functionalized PBI polymer by borylation.

FIG. 2A shows an illustrative reaction scheme for synthesis of a boronic acid-functionalized polystyrene polymer by borylation.

FIG. 2B shows an illustrative reaction scheme for synthesis of a boronic acid-functionalized polymer using a vicinal diol.

FIG. 3A shows an illustrative reaction scheme for synthesis of a boronic acid-functionalized polymer by replacing a pendant sulfonic acid group with a boronic acid group.

FIG. 3B shows an illustrative reaction scheme for synthesis of a boronic acid-functionalized polymer by replacing a pendant sulfonic acid group with a boronic acid group.

FIGS. 4A-4C show illustrative reaction schemes for synthesizing a fluoroboric acid-functionalized polymer by performing a fluoride treatment of a boronic acid-functionalized polymer.

FIGS. 5A and 5B show alternative illustrative reaction schemes for synthesizing a fluoroboric acid-functionalized polymer by performing a fluoride treatment of a boronic acid-functionalized polymer.

FIGS. 6 and 7 show illustrative reaction schemes for synthesizing a fluoroboric acid-functionalized PBI polymer by performing a fluoride treatment of a boronic acid-functionalized PBI polymer.

FIGS. 8 and 9 show alternative illustrative reaction schemes for synthesizing a fluoroboric acid-functionalized PBI polymer by performing a fluoride treatment of a boronic acid-functionalized PBI polymer.

FIGS. 10A and 10B show illustrative reaction schemes for synthesizing a fluoroboric acid-functionalized polystyrene polymer by performing a fluoride treatment of a boronic acid-functionalized polystyrene polymer.

FIGS. 11A and 11B show illustrative reaction schemes for synthesizing a fluoroboric acid-functionalized polymer by performing a fluoride treatment of a boronic acid-functionalized polymer.

FIGS. 12 and 13 show alternative illustrative reaction schemes for synthesizing a fluoroboric acid-functionalized polymer by performing a fluoride treatment of a boronic acid-functionalized polymer.

FIG. 14 shows another illustrative reaction scheme for synthesizing a fluoroboric acid-functionalized polymer.

FIG. 15 shows an illustrative proton exchange membrane water electrolysis system incorporating fluoroboric acid-functionalized polymer PEMs and/or ionomers.

FIG. 16 shows an illustrative proton exchange membrane fuel cell including fluoroboric acid-functionalized polymer PEMs and/or ionomers.

### DETAILED DESCRIPTION

A tetra-coordinated boronic acid-functionalized polymer molecule includes a main chain, a side chain or a side group linked to the main chain, and a pendant tetra-coordinated boronic acid group in a side chain or a side group. The pendant tetra-coordinated boronic acid group includes a tetra-coordinated boron atom having a negative formal charge and counterbalanced by a cation (e.g., a proton). The tetra-coordinated boronic acid-functionalized polymer may be formed by post-polymerization functional modification of a boronic acid-functionalized polymer, such as a boronic acid-functionalized PBI polymer, polystyrene polymer, or PTFE polymer.

Tetra-coordinated boronic acid-functionalized polymers, as described herein, may be used in electrochemical cell applications, such as in PEMs, ionomers, catalyst layers, and membrane electrode assemblies (MEAs). Ionomers and PEMs based on tetra-coordinated boronic acid-functionalized polymers reduce or eliminate catalyst poisoning as compared with sulfonic acid-functionalized polymers. In some examples, tetra-coordinated boronic acid-functionalized polymers comprise tetra-coordinated boronic acid-functionalized PTFE polymers, which are highly effective PTFE polymers for PEM and ionomer applications, keeping the facilities of Nafion™ and Aquivion® intact while reducing or eliminating the contentious issues of catalyst poisoning and de-polymerization (polymer instability). Unlike conventional polymers comprising pendant sulfonic acid groups, tetra-coordinated boronic acid-functionalized polymers remain stable without polymer unzipping (i.e., de-polymerization) under the demanding electrochemical conditions of water electrolysis and hydrogen fuel cells.

Various definitions will now be provided to aid in understanding various aspects of the present disclosure. As used herein, each term or expression, e.g. alkyl, m, n, etc., when used more than once, is intended to be independent of its definition elsewhere in this disclosure. In case of conflict with any patent application or patent incorporated herein by reference, the present specification, including definitions, will control.

As used herein, “polymer” refers to a substance comprising polymer molecules of the same or different polymer species, including a mixture of polymer molecules of the same polymer species which may differ from other polymer molecules within the same sample in chain length and/or particular structural arrangement (e.g., irregularities in the orientation of monomer units, end-groups, and/or in the locations and/or lengths of any side chains or side groups). “Polymer” includes homopolymers, copolymers, terpolymers, interpolymers, and so on.

As used herein, “polymer molecule” or “macromolecule” refers to a molecule of high relative molecular mass, the structure of which comprises a relatively large repetition of units (e.g., about 100 or more monomer units) derived, actually or conceptually, from molecules of low relative molecular mass (e.g., monomer molecules).

As used herein, “polymerization” refers to the process of converting a monomer, or a mixture of monomers, into a polymer.

As used herein, “oligomer” refers to a substance composed of oligomer molecules.

As used herein, “oligomer molecule” refers to a molecule of intermediate relative molecular mass, the structure of which comprises a relatively small repetition of units (e.g., about 5 to about 100 monomer units) derived, actually or conceptually, from molecules of lower relative molecular mass (e.g., monomer molecules).

As used herein, “oligomerization” refers to the process of converting a monomer or a mixture of monomers into an oligomer.

The principles, concepts, and features described herein with reference to polymers, polymer molecules, and polymerization apply equally to oligomers, oligomer molecules, and oligomerization, respectively. Accordingly, any and all uses of the terms polymer, polymer molecule, and polymerization herein can be substituted by the terms oligomer, oligomer molecule, and oligomerization, respectively, without departing from the scope of the disclosure herein.

As used herein, “ionomer” refers to a polymer composed of ionomer molecules.

As used herein, “ionomer molecule” refers to a polymer molecule in which a small but relatively significant proportion of the constitutional units have ionizable or ionic pendant groups (including the ion exchange groups described herein), or both. Generally, no more than approximately 15 mole percent of the constitutional units have ionizable or ionic pendant groups.

As used herein, “monomer” refers to a substance composed of monomer molecules.

As used herein, “monomer molecule” refers to a molecule that can undergo polymerization or oligomerization to form a polymer molecule or an oligomer molecule. A monomer molecule contributes constitutional units to the essential structure of a polymer molecule or an oligomer molecule.

As used herein, “copolymer” refers to a polymer derived from more than one species of monomer.

As used herein, “constitutional unit” refers to an atom or a group of atoms (with pendant atoms or groups, if any) comprising a part of the structure of a polymer molecule (or oligomer molecule, block, or chain).

As used herein, “repeating unit” refers to the constitutional unit the repetition of which constitutes a polymer molecule (or oligomer molecule, block, or chain).

As used herein, “monomer unit” refers to the largest constitutional unit contributed by a single monomer molecule to the structure of a polymer molecule or an oligomer molecule.

As used herein, “block” refers to a portion of a polymer molecule (or oligomer molecule) comprising many constitutional units and that has at least one feature which is not present in the adjacent portions.

As used herein, “chain” refers to the whole or part of a polymer molecule (or oligomer molecule or block), comprising a linear or branched sequence of constitutional units between two boundary constitutional units, each of which may be either an end-group, a branch point, or an otherwise-designated characteristic feature of the polymer molecule.

As used herein, “main chain” or “backbone” refers to the chain of a polymer molecule to which all other chains (long or short or both) may be regarded as being pendant (e.g., a side chain).

As used herein, “side chain” refers to an oligomeric (short chain) or polymeric (long chain) offshoot from the main chain of a polymer molecule.

As used herein, “side group” or “pendant group” refers to an offshoot, neither oligomeric nor polymeric, from a chain (e.g., from a main chain).

The principles, concepts, and features described herein with reference to side chains apply equally to side groups. Accordingly, any and all uses of the term side chain can be substituted by the term side group without departing from the scope of the disclosure herein.

As used herein, “crosslink” refers to a small region in a polymer molecule from which at least four chains emanate. A crosslink is generally formed by reactions involving sites or groups on existing polymer molecules or by interactions between existing polymer molecules.

The term “crosslinked” refers to the state in which polymer molecules that were earlier separate polymer molecules are linked to one another at points other than their ends, usually by covalent bonds.

As used herein, a “catalyst particle” refers to a particle in “black” or pure form (e.g., exclusive of any catalyst support to which the catalyst particle may be bound and exclusive of any catalyst additives) that increases the rate of a reaction without modifying the overall standard Gibbs free energy change in the reaction. A catalyst particle may be an individual molecule (including but not limited to a monomer molecule), a group of molecules, a crystal structure (e.g., as in a metal oxide), a polymer molecule, or an oligomer molecule. A catalyst particle may have any suitable size and shape, such as a microparticle, a nanoparticle, or a nanotube. A catalyst particle may include, for example, a metal, a metal alloy, a metal oxide, a metal halide (e.g., a metal chloride), or a composite including at least one of a metal, a metal alloy, a metal oxide, or a metal halide.

As used herein, an “electrocatalyst particle” or “electrochemical catalyst particle” refers to a catalyst particle that reduces the activation energy needed to carry out electrochemical reactions and/or increases the rate of electrochemical reactions, such as the OER, HER, HOR, and/or ORR. Suitable electrocatalyst particles may include, without limitation, metals such as platinum group metals (PGMs) (e.g., platinum, palladium, iridium, ruthenium, osmium, and rhodium), transition metals (e.g., silver, gold, cobalt, copper, iron, nickel, rhenium, and mercury), and post-transition metals (e.g., bismuth and tin), metal alloys (e.g., PGM-transition metal based alloys and platinum-ruthenium based alloys), metal oxides (e.g., PGM oxides, such as iridium(IV) oxide, ruthenium(IV) oxide, iridium ruthenium oxide, platinum(IV) oxide, magnesium oxide, and cerium(IV) oxide), metal halides (e.g., platinum(IV) chloride, iridium(III) chloride, platinum(IV) bromide, iridium(III) bromide), and/or composites of metals, metal alloys, metal oxides, and/or metal halides.

As used herein, a “catalyst support” refers to a substance, exclusive of a catalyst particle, that may be used to support catalyst particles (e.g., a substance or material to which catalyst particles may be bound or on which catalyst particles may be supported). Examples of catalyst supports include, without limitation, carbon-based materials (e.g., carbon black, graphite, carbon nanotubes, graphene, and/or boron-functionalized carbon materials described herein), titanium dioxide, Sb-doped SnO2 nanoparticles, tin-doped indium oxide (ITO), and/or the ion exchange-modified catalyst supports described in International Patent Application No. PCT/US2022/046105, filed Oct. 7, 2022, the contents of which are incorporated herein by reference in their entirety.

As used herein, a “catalyst” refers to a catalyst particle as well as a catalyst particle together with a catalyst support on which the catalyst particle is supported or to which the catalyst particle is bound. A catalyst may also include catalyst additives, such as promoters (such as, but not limited to, metalloids).

As used herein, an “electrocatalyst” or “electrochemical catalyst” refers to an electrocatalyst particle in “black” or pure form as well as an electrocatalyst particle together with a catalyst support on which the electrocatalyst particle is supported or to which the catalyst particle is bound. An electrocatalyst may also include catalyst additives, such as promoters.

As used herein, “metal” includes alkali metals, alkaline earth metals, transition metals, lanthanides, actinides, and post-transition metals.

As used herein, “transition metals” refers to elements of the d-block of the periodic table (Groups 3 to 12, inclusive).

As used herein, “post-transition metals” refers to aluminum, gallium, indium, tin, thallium, lead, bismuth, and polonium.

As used herein, “metalloids” refers to boron, silicon, germanium, arsenic, antimony, tellurium, and astatine.

As used herein, “platinum group metals” or “PGMs” refers to platinum, palladium, iridium, ruthenium, osmium, and rhodium.

As used herein, “aliphatic” compounds are hydrocarbons that are saturated or unsaturated, acyclic or cyclic, unbranched or branched, unsubstituted or wholly or partly substituted with one or more substituents or functional groups. As will be appreciated by one of ordinary skill in the art, “aliphatic” is intended herein to include, but is not limited to, alkyl, alkenyl, and alkynyl moieties. Illustrative aliphatic groups include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, and sec-hexyl moieties.

As used herein, the term “alkyl” is given its ordinary meaning in the art and may include saturated aliphatic groups, including straight-chain alkyl groups, branched-chain alkyl groups, cycloalkyl (alicyclic) groups, alkyl substituted cycloalkyl groups, and cycloalkyl substituted alkyl groups. An analogous convention applies to other generic terms such as “alkenyl,” “alkynyl,” and the like. Furthermore, as used herein, the terms “alkyl,” “alkenyl,” “alkynyl,” and the like encompass both wholly or partly substituted and unsubstituted groups.

In some embodiments, a straight or branched alkyl chain may have 1 to 30 carbon atoms in its backbone, and, in some cases, 1 to 20 or fewer. In some embodiments, a straight or branched alkyl chain has 1 to 10 carbon atoms in its backbone (e.g., C1-C10 for straight chain, C3-C10 for branched chain), has 6 or fewer carbon atoms, or has 4 or fewer carbon atoms. Cycloalkyls may have from 3 to 10 carbon atoms in their ring structure or, in some case, from 3 to 5, 6 or 7 carbon atoms in the ring structure. Examples of non-cyclic alkyl groups include, but are not limited to, methyl, ethyl, propyl, isopropyl, butyl, isobutyl, n-butyl, tert-butyl, n-pentyl, neopentyl, n-hexyl, n-heptyl, n-octyl, n-decyl, n-undecyl, and dodecyl. Examples of cyclic alkyl groups include, but are not limited to, cyclopropyl cyclobutyl, and cyclochexyl.

The terms “alkenyl” and “alkynyl” refer to unsaturated aliphatic groups analogous in length and possible substitution to the alkyls described above, but that contain at least one double or triple bond respectively. Alkenyl groups include, but are not limited to, for example, ethenyl, propenyl, butenyl, 1-methyl-2-buten-1-yl, and the like. Non-limiting examples of alkynyl groups include ethynyl, 2-propynyl (propargyl), 1-propynyl, and the like.

The term “heteroalkyl” refers to an alkyl group in which one or more hydrogen atoms bonded to any carbon of the alkyl group or one or more carbon atoms are replaced by a heteroatom. A heteroatom is any atom other than carbon. In some examples, a heteroatom is an atom selected from the group consisting of N, O, P, B, S, Si, Sb, Al, Sn, As, Se and Ge. Examples of heteroalkyl groups include, without limitation, methoxy, ethoxy, propoxy, isopropoxy, methylthio, ethylthio, propylthio, isopropylthio, n-butylthio, methoxymethyl, and cyano groups.

The terms “heteroalkenyl” and “heteroalkynyl” refer to unsaturated aliphatic groups analogous in length and possible substitution to the heteroalkyls described above, but that contain at least one double or triple bond respectively.

The term “aryl” refers to aromatic carbocyclic groups, unsubstituted or wholly or partly substituted, having a single ring (e.g., phenyl), multiple rings (e.g., biphenyl), or multiple fused rings, in which at least one ring is aromatic (e.g., 1,2,3,4-tetrahydronaphthyl, naphthyl, anthryl, or phenanthryl). That is, at least one ring may have a conjugated Pi electron system, while other, adjoining rings can be cycloalkyls, cycloalkenyls, cycloalkynyls, aryls, and/or heterocycyls. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl group. Examples of aryl groups include, without limitation, phenyl, naphthyl, tetrahydronaphthyl, indanyl, and indenyl.

The term “heteroaryl” refers to aryl groups comprising at least one heteroatom as a ring atom, such as a heterocycle. Non-limiting examples of heteroaryl groups include, without limitation, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, and isoquinolinyl.

The terms “alkoxyl” or “alkoxy” as used herein refers to an alkyl group having an oxygen radical attached thereto, and has the general formula R—O. Examples of alkoxyl groups include, without limitation, methoxy, ethoxy, propyloxy, and tert-butoxy groups.

The term “aryloxy” refers to an aryl group having an oxygen radical attached thereto. An example of an alkoxyl group includes, without limitation, a phenoxy group.

Any of the above groups may be optionally substituted, in whole or in part. Examples of substituents include, without limitation, aliphatic, alicyclic, heteroaliphatic, heteroalicyclic, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, alkyloxycarbonyl, silyl, ether, alkylthio, heteroalkylthio, heteroarylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, (e.g., SO4(R′)₂), a phosphate (e.g., PO4(R′)₃), a silane (e.g., Si(R′)₄), a urethane (e.g., R′O(CO)NHR′), and the like. Additionally, the substituents may be selected from F, Cl, Br, I, —OH, —NO₂, —CN, —NCO, —CF₃, —CH₂CF₃, —CHCl₂, —CH₂ORx, —CH₂CH₂ORx, —CH₂N(Rx)₂, —CH₂SO₂CH₃, —C(O)Rx, —O₂(Rx), —CON(Rx)₂, —OC(O)Rx, —C(O)OC(O)Rx, —OCO₂Rx, —OCON(Rx)₂, —N(Rx)₂, —S(O)₂Rx, —OCO₂Rx, —NRx(CO)Rx, —NRx(CO)N(Rx)₂, wherein each occurrence of Rx independently includes, but is not limited to, hydrogen, aliphatic, alicyclic, heteroaliphatic, heteroalicyclic, aryl, heteroaryl, alkylaryl, or alkylheteroaryl, wherein any of the aliphatic, alicyclic, heteroaliphatic, heteroalicyclic, alkylaryl, or alkylheteroaryl substituents described above and herein may be wholly or partly substituted or unsubstituted, branched or unbranched, cyclic or acyclic, and wherein any of the aryl or heteroaryl substituents described above and herein may be wholly or partly substituted or unsubstituted.

Tetra-coordinated boronic acid-functionalized polymers, such as fluoroboric acid-functionalized polymers, as described herein, may be used in PEM and ionomer applications. In some examples, tetra-coordinated boronic acid-functionalized polymers are synthesized by post-polymerization functional modification of PEM polymers, such as polybenzimidazole (PBI) polymers, sulfonic acid-functionalized PTFE polymers, sulfonic acid-functionalized polymers, polystyrene polymers, and/or boronic acid-functionalized derivatives of any of the foregoing polymers.

Polybenzimidazole (PBI) polymers are a class of polymers composed of PBI polymer molecules. PBI polymer molecules have a repeating unit that includes a benzimidazole unit as at least part of a main chain. The benzimidazole unit comprises a benzimidazole moiety or a derivative thereof. Benzimidazole is a heterocyclic aromatic organic compound having a phenyl group and an imidazole group that share two carbon atoms in their ring structures. The general structure of benzimidazole is shown in the following Formula (I):

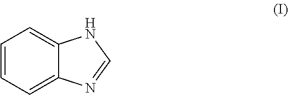

An example of a PBI polymer with one benzimidazole unit per repeating unit in a main chain is poly(2,5-benzimidazole) (AB-PBI), shown below as Formula (II), and examples of PBI polymers with two benzimidazole units per repeating unit in a main chain are poly[2,2′-(m-phenylene)-5,5′-bibenzimidazole](m-PBI), shown below as Formula (III), and 4F-PBI (a fluorinated derivative of m-PBI), shown below as Formula (IV).

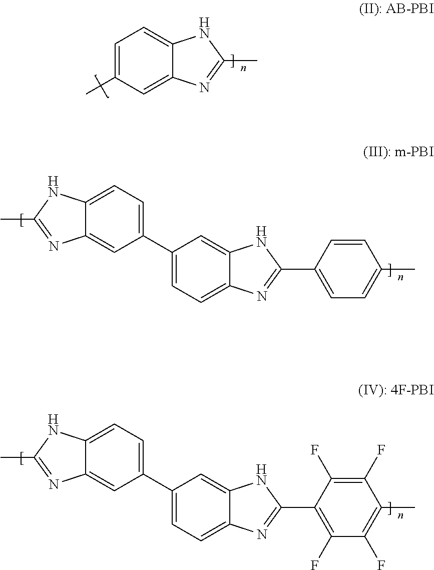

Other examples of PBI polymers include, without limitation, poly{2,6-(2,6-naphtyliden)-1,7-dihydrobenzo[1,2-d;4,5-d′]diimidazole}; poly 2,2′-(2,6-naphtyliden)-5,5′-bibenzimidazole; poly-2,2′-(2,6-pyridine)-5,5′-bibenzimidazole; poly-2,2′-(2,5-pyridine) 5,5′-bibenzimidazole; poly-2,2′-(2,2′-bipyridine-5,5′)-5,5′-bibenzimidazole); poly-2,2′-(3,5-pyrazole)-5,5′-bibenzimidazole; poly-2,2′-(m-phenylene)-5,5′-bibenzimidazole; poly-2,2′-(pyridylene-3″, 5″)-5,5′-bibenzimidazole; poly-2,2′-(furylene-2″,5″)-5,5′-bibenzimidazole; poly-2,2-(naphthalene-1 “,6″)-5,5′-bibenzimidazole; poly-2,2′-(biphenylene-4”,4″)-5,5′-bibenzimidazole; poly-2,2′-amylene-5,5′-bibenzimidazole; poly-2,2′-octamethylene-5,5′-bibenzimidazole; poly-2,6-(m-phenylene)-diimidazolebenzene; poly-2,2′-cyclohexenyl-5,5′-bibenzimidazole; poly-2,2′-(m-phenylene)-5.5′di(benzimidazole)ether; poly-2,2′-(m-phenylene)-5,5-di(benzimidazole)sulfide; poly-2,2′-(m-phenylene)-5,5-di(benzimidazole)sulfone; poly-2,2′-(m-phenylene)-5,5-di(benzimidazole)methane; poly-2-2″-(m-phenylene)-5″0.5″-(di(benzimidazole)propane 2.2; poly-2.2″-(m-phenylene)-5′5″-di(benzimidazole)ethylene-1,2; and derivatives of any of the foregoing (including substituted (e.g., fluorinated) and/or branched derivatives). In some examples, a PBI polymer is a copolymer that comprises one or more additional repeating units, which may or may not include a benzimidazole unit in a main chain, in a side chain, or both.

Polytetrafluoroethylene (PTFE) polymers are a class of polymers composed of tetrafluoroethylene polymer molecules, and derivatives thereof, and are produced by the polymerization of tetrafluoroethylene. PTFE polymer molecules have a carbon main chain with two fluorine atoms bonded to each carbon, and derivatives thereof.

Polychlorotrifluoroethylene (PCTFE) polymers are derivatives of PTFE and are homo-polymers of chlorotrifluoroethylene (CTFE) with the molecular formula (CF₂CClF)ₙ, and derivatives thereof. PCTFE is similar to PTFE (such as Teflon) except that PCTFE contains a chlorine atom in each repeating unit. The presence of this chlorine atom makes PCTFE a unique thermoplastic polymer with many applications. However, PCTFE has a hydrophobic main chain and is non-conducting for ions and thus is not suitable for electrochemical applications. Derivatives of PCTFE polymers include substituent groups (e.g., side chains or side groups) in place of chlorine atoms. Derivatives of PCTFE may be wholly or partly substituted. Derivatives of PCTFE polymers include, without limitation, modified and functionalized PCTFE polymers, including any of the modified or functionalized PCTFE polymers (e.g., acid-functionalized and ion-exchange functionalized PCTFE polymers) described in U.S. Provisional Application No. 63/532,262, filed Aug. 11, 2023, which is hereby incorporated by reference in its entirety.

Sulfonic acid-functionalized PTFE polymers are derivatives of PTFE polymers and have a PTFE main chain and a side chain or side group with one or more pendant sulfonic acid groups. In some examples, the side chain is a long side chain (LSC) having at least two ether linkages and four or more polyfluorinated carbon units (e.g., —CF₂— and/or —CF₃). In other examples, the side chain is a short-side chain (SSC) having one ether linkage and two polyfluorinated carbon units. In further examples, the side chain is a mid-side chain (MSC) having one ether linkage and four polyfluorinated carbon units. In some examples, a sulfonic acid-functionalized PTFE polymer has the general formula [(CF₂CF₂)ₘ(CFACF₂)ₙ]ₓ, where A is a side chain comprising one or more pendant sulfonic acid groups, and m, n, and x are positive and are selected based on application, equivalent weight, molecular weight, etc. In some examples, m ranges from 4 to 7 and n is 1. In some examples, side chain A is a LSC, MSC, or SSC. Examples of LSC sulfonic acid-functionalized PTFE polymers include, without limitation, Nafion™ series polymers (available from Chemours Company in various configurations and grades, including Nafion-H, Nafion HP Nafion 117, Nafion 115, Nafion 212, Nafion 211, Nafion NE1035, Nafion XL, etc.) and any combination, derivative, grade, or configuration thereof. Examples of SSC sulfonic acid-functionalized PTFE polymers include, without limitation, Aquivion® series polymers (available from Solvay S.A. in different configurations and grades, including Aquivion® E98-05, Aquivion® PW98, Aquivion® PW87S, etc.), Gore-Select® (available from W.L. Gore & Associates, Inc.), Flemion™ (available from Asahi Glass Company), Pemion+™ (available from Ionomr Innovations, Inc.), and any combination, derivative, grade, or configuration thereof. Examples of MSC sulfonic acid-functionalized PTFE polymers include, without limitation, polymers produced by 3M™ Company. In some examples, a PTFE polymer is a copolymer that comprises one or more other repeating units. In some examples, a PTFE polymer may be doped and/or may be crosslinked with itself and/or with another polymer.

Sulfonic acid-functionalized polymers include, without limitation, polyfluorosulfonic acid polymers and non-fluorinated sulfonic acid polymers. Examples of polyfluorosulfonic acid polymers include, without limitation, sulfonic acid-functionalized PTFE polymers and sulfonic acid-functionalized PCTFE polymers. Examples of non-fluorinated sulfonic acid polymers include, without limitation, poly(styrene sulfonic acid) polymers, sulfonated aromatic polymers (e.g., sulfonated poly(ether ketone) (SPEEK) polymers, sulfonated poly(aryl ether sulfone) (SPAES) polymers, sulfonated poly(arylene ether ketone) (SPAEK) polymers, sulfonated polysulfone (SPSF) polymers, sulfonated polyimide (SPI) polymers, and sulfonated polystyrene (SPS), sulfonated polyphenylene, and any other sulfonated polymer, including sulfonated derivatives of polymers described herein.

Polystyrene polymers are polymers composed of polystyrene polymer molecules. Polystyrene polymer molecules have a repeating unit that includes alternating carbon centers attached to a phenyl group. Examples of polystyrene polymers include, without limitation, polystyrene, poly(styrene sulfonic acid) (e.g., poly(4-styrene sulfonic acid)), polyhalostyrene, poly(3-trifluoromethyl styrene), poly(4-acetoxy styrene), poly(4-allyl styrene), poly(4-cyanostyrene), poly(4-dimethylsilyl styrene), poly(4-hydroxystyrene), poly(alpha-methyl styrene), poly(4-methyl styrene), poly(4-methoxystyrene), poly(4-[tert-butoxycarbonyl]oxy-styrene), poly(4-tert-butyl styrene), poly(4-[N,N-di(trimethylsilyl)aminomethyl]-styrene), poly(4-vinylbenzoic acid), poly(n-butyl 4-vinylbenzoate), poly(tert-butyl 4-vinylbenzoate), poly(2-ethylhexyl 4-vinylbenzoate), poly(methyl 4-vinylbenzoate), poly(vinylbenzyl chloride), poly(4-vinylbenzyl-N-methylphthalimide), poly(vinyl cyclohexane), and derivatives of any of the foregoing (including substituted (e.g., fluorinated) and/or branched derivatives). In some examples, a polystyrene polymer is a copolymer that comprises one or more additional repeating units, which may or may not include a carbon center attached to a phenyl group.

Aromatic polymers include any polymers having aromatic rings in a main chain and/or in side chains or side groups. Examples of aromatic polymers include, without limitation, polystyrene polymers, polycarbonate polymers (polyphenylene polymers (e.g., poly(1,4-phenylene), poly(1,4-phenylene-ethylene), poly(1,3-phenylene-methylene), poly(p-phenylene vinylidene), poly(p-phenylene vinylene), poly(1,4-phenylene oxide), poly(1,4-phenylene sulfide)), poly(ether sulfone), polyaryletherketone polymers, polysulfone polymers, poly(ethylene terephthalate), aromatic polyester polymers, poly(oxy-1,4-phenylenecarbonyl-1,4-phenylene), poly[(dimethylmethylene)bis(4,1-phenylene) carbonate], phenolic resins, poly[(ethylazanediyl)ethyleneazanediyl-1,3-phenylene], poly-oxydiphenylene-pyromellitimide (Kapton®, manufactured by E. I. du Pont de Nemours and Company), poly(ester imide) polymers, aromatic polyimide polymers, lignin, and derivatives of any of the foregoing (including substituted (e.g., fluorinated) and/or branched derivatives).

Natural polymers (also referred to as “biopolymers”) include, without limitation, cellulose, lignin, chitin, and derivatives of any of the foregoing, including any of the polymers described in U.S. Pat. No. 11,331,631, issued May 17, 2022, and U.S. Pat. No. 11,594,747, issued Feb. 28, 2023, each of which is hereby incorporated by reference in its entirety.

Boronic acid-functionalized polymers may be used for synthesis of tetra-coordinated boronic acid-functionalized polymers, as described in more detail below. A boronic acid-functionalized polymer molecule includes a polymer main chain and a pendant boronic acid group in the main chain or a side chain or side group. The boronic acid group has the general formula —B(OH)₂ or ═B(OH) where the boron atom is covalently bonded to one or two hydroxyl groups and by one or two covalent bonds to the main chain or side chain, with three total covalent bonds. Examples of boronic acid-functionalized polymers include, without limitation, derivatives of PBI polymers, sulfonic acid-functionalized PTFE polymers, sulfonic acid-functionalized PCTFE polymers, sulfonic acid-functionalized polymers, polystyrene polymers, and cellulose polymers functionalized with boronic acid groups. Illustrative reaction schemes for synthesis of boronic acid-functionalized polymers will now be described.

In some examples, a boronic acid-functionalized polymer is formed by post-polymerization functional modification of a polymer molecule. Various examples of post-polymerization functional modification will now be described.

In some examples, a boronic acid-functionalized PBI polymer is synthesized by post-polymerization functional modification of a PBI polymer by coupling a boronic acid-functionalized linker with a secondary nitrogen atom in the benzimidazole moiety in the PBI polymer. The boronic acid-functionalized linker has a linking group X as a terminal group or as a side group and a boronic acid group as a terminal group and/or as a side group, where linking group X is a methyl group (—CH₃), a formyl group (—C(═O)H), or a sulfonyl group (—S(═O)₂H). In some examples, the boronic acid-functionalized linker has the general formula XRB(OH)₂, where R is an alkyl chain of length m, where m ranges from 0 to 30 (or from 0 to 20, or from 0 to 12, or 0 to 10, or 0 to 8, or 0 to 6), and has one or more side groups A, each of which may independently be hydrogen (H), a hydroxyl group (OH), a fluoro group (F), a chloro group (Cl), a boronic acid group, a dialkylamino group (NR′₂, in which R′ may represent hydrogen or an organic combining group, such as a methyl group (CH₃)), a cyano group (CN), a carboxylic acid (COOH) group, a carboxylic amide group, an ester group, an alkyl group, an alkoxy group, or an aryl group. In some examples, the boronic acid-functionalized linker has one or more pendant boronic acid groups as a side group rather than, or in addition to, a terminal group.

In the reaction, linking group X of the boronic acid-functionalized linker bonds with the secondary nitrogen of the benzimidazole moiety, thus forming a side chain with a pendant boronic acid group. The loading of the boronic acid groups may be controlled by tuning the molar ratio of the boronic acid-functionalized linker to the benzimidazole moiety in the PBI polymer.

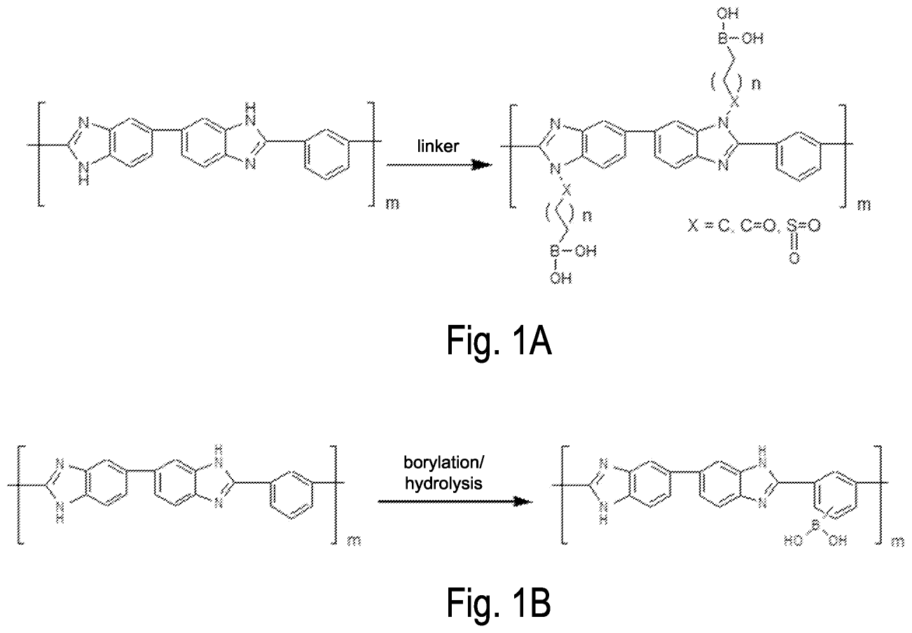

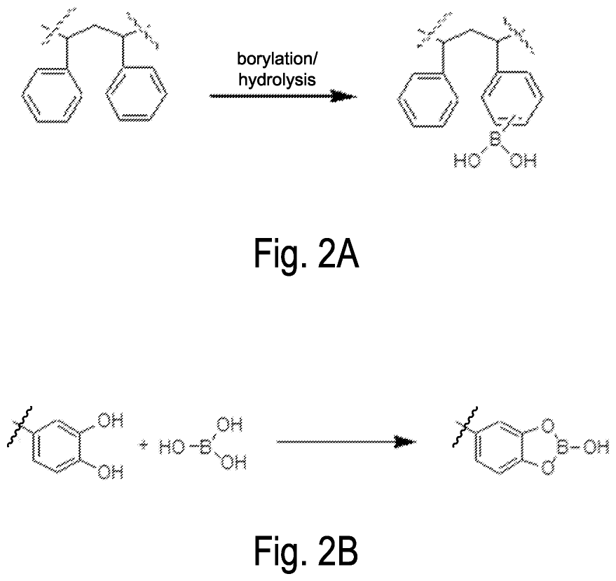

FIG. 1A shows an illustrative reaction scheme for synthesis of a boronic acid-functionalized PBI polymer. As shown, a PBI polymer molecule is combined with a boronic acid-functionalized linker to produce a boronic acid-functionalized PBI polymer molecule. Any boronic acid-functionalized linker described herein may be used. It will be recognized that the PBI polymer molecule of FIG. 1A is merely representative and the reaction scheme of FIG. 1A can be carried out using any other suitable PBI polymer.

In other examples of post-polymerization functional modification, an aromatic polymer is converted into a boronic acid-functionalized polymer by borylation of an aromatic ring in the main chain or a side chain or side group. In some examples, the aromatic ring may be directly borylated by reaction with a borylating agent. Any suitable borylating agent may be used, including, but not limited to, a boronic acid, a borate ester having the general formula B(OR¹)₃ and/or a boronic ester having the general formula R²B(OR¹)₂, where each R¹ is independently an alkyl or aryl group having 1 to 20 carbon atoms, 1 to 10 carbon atoms, 1 to 6 carbon atoms, or 1 to 4 carbon atoms, wholly or partly substituted or unsubstituted, branched or unbranched, and R² is an alkyl, alkenyl, alkynyl, or aryl group having 1 to 20 carbon atoms, 1 to 10 carbon atoms, 1 to 6 carbon atoms, or 1 to 4 carbon atoms, wholly or partly substituted or unsubstituted, and branched or unbranched. Other suitable borylating agents may be used. Illustrative examples of borylating agents include, without limitation, trialkyl borates (e.g., trimethyl borate, triethyl borate), bis(pinacolato)diboron, bis(catecholato)diborane, pinacol borate, bis(2,4-dimethylpentane-2,4-glycolato)diboron, bis(hexylene glycolato)diboron, bis(neopentyl glycolato)diboron, vinyl boronic acid, and derivatives of the foregoing. Borylation reactions of the aromatic ring may also include metal catalyzed C—H borylation reactions, including but not limited to Suzuki-Miyaura metal-catalyzed coupling reactions, which use transition metals to directly convert a C—H bond into a C—B bond.

Borylation of the aromatic ring produces an intermediate protected boronic acid group (e.g., —B(OR¹)₂). In these examples, a hydrolysis step may be performed to remove the protecting groups R¹, thus producing a pendant boronic acid group having general formula —B(OH)₂. In other examples, the hydrolysis step may be performed in situ during the borylation step (e.g., by combining the borylating agent and water in a one-pot process). The loading of the boronic acid groups on the polymer may be controlled by controlling the molar ratio of the borylating agent to the aromatic rings in the polymer. In other examples, the aromatic group (Ar) in the polymer molecule may be first converted to an active “Ar—X” intermediate for the subsequent borylation reaction, where X is a halo group (e.g., an iodo (I), bromo (Br), or chloro (Cl) group) or a metal (where Ar—X is formed by an aromatic ring metalation reaction). In some examples, X is lithium (Li).

FIG. 1B shows an illustrative reaction scheme for synthesis of a boronic acid-functionalized PBI polymer by borylation. As shown, a PBI polymer molecule is combined with a borylating agent. The aromatic ring of the benzimidazole unit is borylated to produce an intermediate protected boronic acid group, which is then hydrolyzed to produce a pendant boronic acid group. Any suitable borylating agent can be used in place of boric acid, and the reaction scheme of FIG. 1B can be carried out using any other suitable PBI polymer.

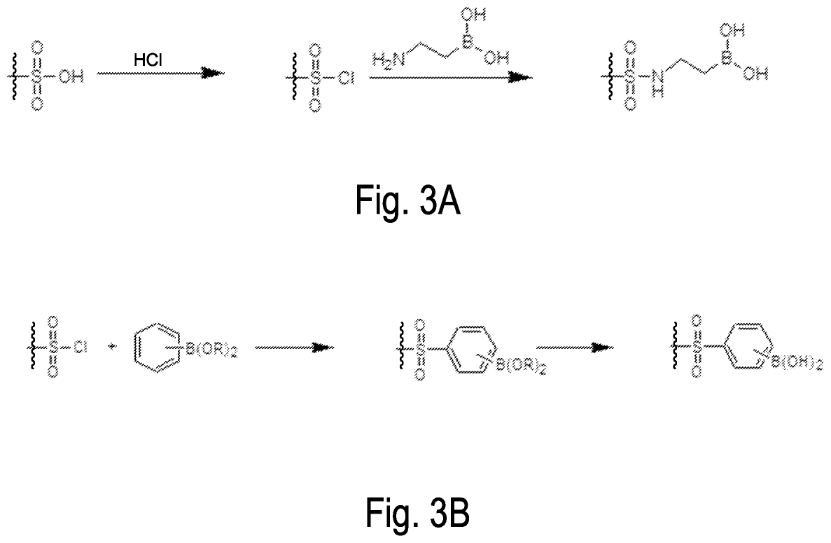

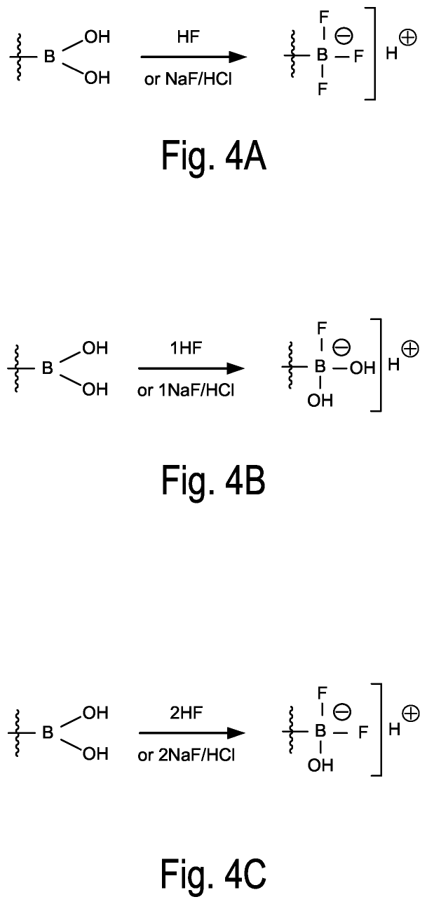

FIG. 2A shows an illustrative reaction scheme for synthesis of a boronic acid-functionalized polystyrene polymer by borylation. As shown, a polystyrene polymer molecule is combined with a borylating agent. An aromatic ring of the polystyrene repeating unit is borylated to produce an intermediate protected boronic acid group, which is then hydrolyzed to produce a pendant boronic acid group. Any suitable borylating agent can be used and the reaction scheme of FIG. 2A can be carried out using any other suitable polystyrene polymer.

In further examples of post-polymerization functional modification of a polymer, a polymer having a vicinal diol in a side group or a side chain is combined with boric acid (B(OH)₃). The boric acid reacts with the vicinal hydroxyl groups to form a cyclic boronic acid group having only one hydroxyl group. Any suitable polymer having a vicinal diol may be used, including polysaccharides, cellulose, and 1,2-dihydroxyphenyl polymers.

FIG. 2B shows an illustrative reaction scheme for synthesis of a boronic acid-functionalized polymer using a vicinal diol. As shown, a polymer molecule having a pendant 1,2-dihydroxyphenyl group is combined with boric acid to produce a boronic acid-functionalized polymer having a pendant boronic acid group. In some examples, the polymer molecule includes a PTFE main chain and the linker is an LSC, MSC, or SSC. Other configurations are also contemplated by the linker. While FIG. 2B shows only one linker, the polymer molecule may have any other suitable number of side chains, linkers, and 1,2-dihydroxyphenyl groups. Additionally, the 1,2-dihydroxyphenyl group may be a part of a side chain or side group of any other polymer described herein, including but not limited to a PBI polymer, a sulfonic acid-functionalized polymer, a polystyrene polymer, or an aromatic polymer. In some examples, cellulose polymers and/or polysaccharides may be used to crosslink a boronic acid-functionalized polymer.

In yet further examples of post-polymerization functional modification of a polymer, a sulfonic acid-functionalized polymer molecule is converted into a boronic acid-functionalized polymer molecule by coupling a boronic acid group with a pendant sulfonic acid group by a sulfonamide link. The reaction scheme includes multiple steps.

In a first step, the sulfonic acid group is activated to sulfonyl chloride (—S(═O)Cl), sulfonyl fluoride (—S(═O)F), or a sulfonic ester. For example, the sulfonic acid-functionalized polymer molecule may be combined with hydrochloric acid (HCl) or hydrofluoric acid (HF), which performs a substitution reaction to replace the hydroxyl group of the sulfonic acid group with a chloride group, thus forming a sulfonyl chloride group or sulfonyl fluoride group. Other suitable chloride reagents and/or fluoride reagents may be used, including but not limited to thionyl chloride, sulfuryl chloride, oxalyl chloride, thionyl fluoride, and sulfuryl fluoride. A sulfonic ester has the general formula —S(═O₂)OR where R is hydrogen or a wholly or partly substituted or unsubstituted alkyl or aryl group having one to twenty, one to ten, one to eight, one to six, or one to four carbon atoms, such as but not limited to a methyl, ethyl, propyl, or butyl group. Examples of sulfonic ester reagents include, without limitation, dimethyl sulfate or a dialkyl sulfate.

In a second step, a bifunctional amino boronic acid linker is coupled with the sulfonyl chloride, sulfonyl fluoride, or sulfonic ester. The bifunctional amino boronic acid linker comprises an amino group as a terminal group or a side group, a boronic acid group as a terminal group or a side group, and a group R, where R is an alkyl chain of length m, where m ranges from 0 to 30 (or from 0 to 20, or from 0 to 12, or 0 to 10, or 0 to 8, or 0 to 6), and has one or more side groups A, each of which may independently be hydrogen (H), a hydroxyl group (OH), a fluoro group (F), a chloro group (Cl), a boronic acid group, a dialkylamino group (NR′2, in which R′ may represent hydrogen or an organic combining group, such as a methyl group (CH3)), a cyano group (CN), a carboxylic acid (COOH) group, a carboxylic amide group, an ester group, an alkyl group, an alkoxy group, or an aryl group. In the second step, a primary or secondary amine in the bifunctional amino boronic acid linker orthogonally couples with the sulfonyl chloride, sulfonyl fluoride, or sulfonic ester, thus linking the amino boronic acid linker to the polymer main chain by a sulfonamide link. The resulting polymer molecule has a pendant boronic acid group linked to the polymer main chain (e.g., a PTFE main chain) by way of the linker (e.g., by way of the sulfonamide link).

In an alternative reaction scheme, in the second step an aromatic boronic acid having the general formula ArB(OR)₂ reacts with the sulfonyl chloride, sulfonyl fluoride, or sulfonic ester by an aromatic electrophilic substitution reaction. In the aromatic boronic acid having the general formula ArB(OR)₂, each R is independently hydrogen or a wholly or partly substituted or unsubstituted alkyl or aryl group having one to twenty, one to ten, one to eight, one to six, or one to four carbon atoms, such as but not limited to a methyl, ethyl, propyl, or butyl group. The aromatic boronic acid is a protected form of boronic acid. In this reaction scheme, the aryl group of the aromatic boronic acid couples directly with the sulfur atom of the sulfonyl chloride, sulfonyl fluoride, or sulfonic ester, forming an intermediate protected aromatic boronic acid group coupled with the polymer by a sulfone link. In a third step, the protecting groups R are removed to yield a free aromatic boronic acid group having the general formula ArB(OH)₂. For example, a hydrolysis step may be performed to remove the protecting groups R, thus producing a pendant boronic acid group having general formula —B(OH)₂ coupled with the main chain by way of an aromatic linker and a sulfone link. In other examples, the hydrolysis step may be performed in situ during the borylation step (e.g., by combining the borylating agent and water in a one-pot process).

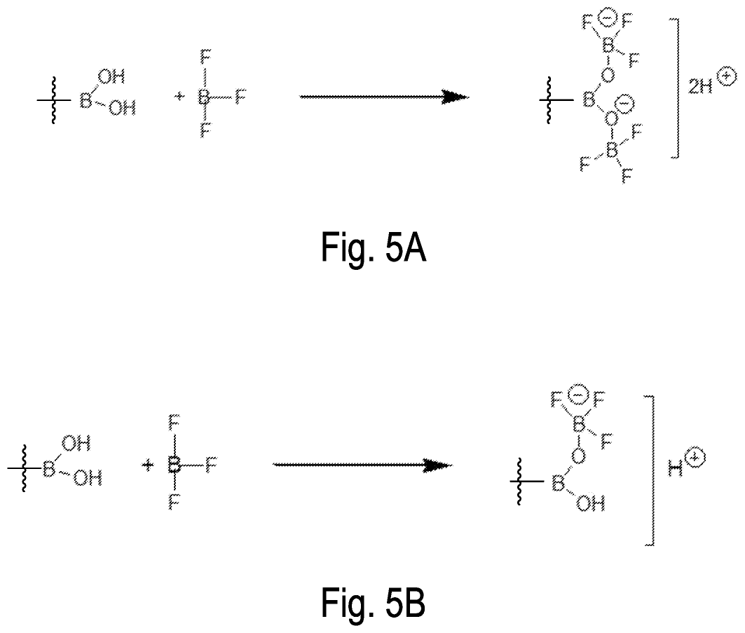

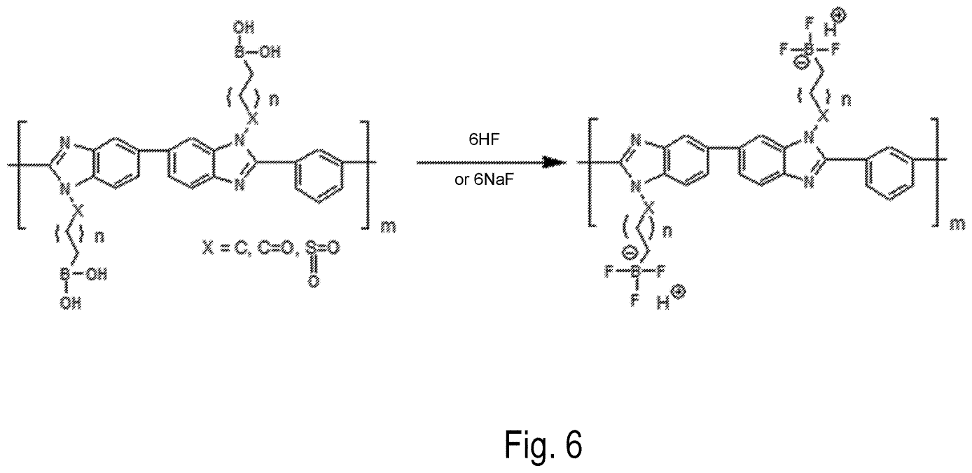

FIG. 3A shows an illustrative reaction scheme for synthesis of a boronic acid-functionalized polymer by coupling a boronic acid group with a pendant sulfonic acid group by a sulfonamide link. Any sulfonic acid-functionalized polymer molecule may be used as a starting reagent, including but not limited to a polyfluorosulfonic acid-functionalized PTFE polymer molecule or a sulfonic acid-functionalized PCTFE polymer molecule. In a first step, a pendant sulfonic acid group of the sulfonic acid-functionalized polymer molecule is activated to sulfonyl chloride, such as by combination with hydrogen chloride. However, the sulfonic acid group may be activated to sulfonyl chloride using any other chloride activation agent. Additionally, the sulfonic acid group may alternatively be activated to sulfonyl fluoride or a sulfonic ester. In a second step, the intermediate sulfonyl chloride-functionalized polymer molecule is combined with an amino boronic acid linker, which couples with the sulfonyl chloride by a sulfonamide link. In the example of FIG. 3A, the amino boronic acid linker has the formula H₂N(CH)₂B(OH)₂. However, any other amino boronic acid linker may be used, including any amino boronic acid linker described herein.

FIG. 3B shows an illustrative reaction scheme for synthesis of a boronic acid-functionalized polymer by coupling a boronic acid group with a pendant sulfonic acid group by a sulfone link. In the second step, a sulfonyl chloride-functionalized polymer molecule is combined with phenylboronic acid having the general formula PhB(OR)₂, where each R is independently hydrogen or a wholly or partly substituted or unsubstituted alkyl or aryl group having one to twenty, one to ten, one to eight, one to six, or one to four carbon atoms, such as but not limited to a methyl, ethyl, propyl, or butyl group. The phenylboronic acid couples with the sulfonyl chloride by a sulfone link to form an intermediate protected phenylboronic acid-functionalized polymer molecule. In a third step, the protecting groups R are removed from the intermediate phenylboronic acid-functionalized polymer molecule, as described above, to yield a polymer molecule having a pendant phenyl boronic acid group having the general formula PhB(OH)₂ coupled with the polymer main chain by a sulfone link. In the example of FIG. 3B, any other aromatic boronic acid may be used in place of phenylboronic acid. Additionally, the aromatic boronic acid may be combined with sulfonyl fluoride or a sulfonic ester instead of sulfonyl chloride.

In the examples described above, a boronic acid-functionalized polymer is synthesized by post-polymerization functional modification of a polymer. In other examples, a boronic acid-functionalized polymer is synthesized by polymerization reactions using a boronic acid-functionalized monomer. For example, a monomer used to form a polymer, such as a tetrafluoroethylene (TFE) monomer, benzimidazole monomer, styrene polymer, or sulfonic acid-functionalized monomer, may be modified pre-polymerization with a boronic acid group, after which the functionalized monomer is polymerized to form a boronic acid-functionalized polymer. The monomer may be functionally modified with a boronic acid group in any way, including using any reaction scheme described herein for functional modification of a polymer with a boronic acid group.

In some examples, boronic acid-functionalized polymers are used to synthesize tetra-coordinated boronic acid-functionalized polymers, including fluoroboric acid-functionalized polymers. Tetra-coordinated boronic acid-functionalized polymers as described herein take advantage of the unique chemical bonding properties of boron. Boron has three valence electrons and has a ground state electron configuration of 1s²2s²2p¹. Boron forms trivalent, trigonal neutral compounds, such as boric acid (B(OH)₃), boronic acid (RB(OH)₂ or R¹R²B(OH)), and boronic acid groups (a boronic acid where R is a part of a main chain or side chain of a polymer), in which boron has three covalent bonds through sp² hybridization. The sp² hybridized boron atom contains an empty p-orbital, which makes trivalent boron compounds strongly electron-deficient, two electrons short of a stable octet electronic configuration. Thus, boric acid and boronic acids are Lewis acids and readily accept an electron pair at the boron atom. Addition of an anion, such as fluoride (e.g., by a fluoride treatment) or other anion, makes the octet electronic configuration, forming highly stable, negatively charged tetravalent, tetrahedral boron compounds with four covalent bonds. Tetravalent boron may also be synonymously called tetra-coordinated boron. Polymers may be functionalized with functional groups having tetra-coordinated boron, such as tetra-coordinated boronic acid groups (e.g., fluoroboric acid groups). Functional groups including tetra-coordinated boron have a negative formal charge and thus are intrinsically ionic and acidic and may serve as cation transport agents in electrochemical cell applications.

Tetra-coordinated boronic acid-functionalized polymer molecules have a main chain and a tetra-coordinated boronic acid group in a side chain and/or side group. A tetra-coordinated boronic acid group has the general formula —BFₘXₙ(OH)₍₃₋ₘ₋ₙ₎ where B has four covalent bonds and is covalently bonded to a polymer main chain, side chain, or side group; m and n are each independently 0, 1, 2, or 3; the sum of m+n is 1, 2, or 3; and X is an anion other than fluoride. In some examples, X is a conjugate base derived from a compound of the general formula HX (a Brønsted-Lowry acid), such as, but not limited to, alkylsulfonic acids having general formula RSO₂(OH) where R is an alkyl group (e.g., methanesulfonic acid (CH₃SO₃H), vinylsulfonic acid, perfluorooctanesulfonic acid, taurine), arylsulfonic acids having general formula ArSO₂(OH) where Ar is an aryl group (e.g., benzenesulfonic acid (C₆H₅SO₃H), p-toluenesulfonic acid (C₇H₇SO₃H)), alkylarylsulfonic acids (e.g., alkylbenzenesulfonic acids); sulfuric acid (H₂SO₄) (e.g., ammonium bisulfate ((NH₄)HSO₄), pyridinium bisulfate, any nitrogen heterocycle bisulfate, alkylammonium bisulfates, and sulfamic acid), phosphoric acids, phosphinic acids, carboxylic acids, phenols, and derivatives of any of the foregoing. X may be derived from both small molecule and polymeric Brønsted-Lowry acids. In the cases of polymeric Brønsted-Lowry acids, the chemistry will bring in cross-linking, providing a wider range of applications. Tetra-coordinated boronic acid-functionalized polymers encompass a broad range of polymers, including, without limitation, tetra-coordinated boronic acid-functionalized PTFE polymers, tetra-coordinated boronic acid-functionalized PCTFE polymers, tetra-coordinated boronic acid-functionalized polystyrene polymers, tetra-coordinated boronic acid-functionalized cellulose polymers, and tetra-coordinated boronic acid-functionalized PBI polymers.

In some examples, a tetra-coordinated boronic acid-functionalized polymer molecule is synthesized by a nucleophilic substitution reaction between a pendant boronic acid group of a boronic acid-functionalized polymer molecule and a fluoride reagent (described below) and/or the compound HX (described above). The boron atom accepts a fluoride anion (F⁻) from the fluoride reagent and/or an X⁻ anion from HX and, depending on the reaction stoichiometry, substitutes the fluoride anion F⁻ and/or X⁻ anion for one or more of the hydroxyl groups by a nucleophilic substitution reaction. Due to the tetra-coordinated boron atom, a tetra-coordinated boronic acid group in a tetra-coordinated boronic acid-functionalized polymer molecule has a negative formal charge and is counterbalanced by a proton.

The degree of anion loading on boronic acid groups, and thus the pKa of the resulting tetra-coordinated boronic acid-functionalized polymer, may be tuned as desired based on the stoichiometry of the reagents. For example, where the molar ratio of HX to boronic acid groups is 3 or more to 1 (23:1), the resulting tetra-coordinated boronic acid group has the formula —BX₃. Where HX is the limiting reagent, the pKa of the resulting tetra-coordinated boronic acid-functionalized polymer will be higher than where HX is not limiting. For example, where the molar ratio of HX to boronic acid groups is 2 to 1 (2:1), the resulting tetra-coordinated boronic acid group has the formula —BX₂(OH). Where the molar ratio of HX to boronic acid groups is 1 to 1 (1:1), the resulting tetra-coordinated boronic acid group has the formula —BX(OH)₂.

In some examples, the tetra-coordinated boronic acid-functionalized polymer is a fluoroboric acid-functionalized polymer. A fluoroboric acid-functionalized polymer molecule has a polymer main chain and a fluoroboric acid group in a side chain and/or side group. A fluoroboric acid group includes a tetra-coordinated boron atom covalently bonded to at least one fluorine atom and has the general formula —BFₘXₙ(OH)₍₃₋ₘ₋ₙ₎ where m is 1, 2, or 3; n is 0, 1, or 2; and the sum of m+n is 1, 2, or 3. In some examples, the fluoroboric acid group has the formula —BF₃, —BF₂(OH), or —BF(OH)₂, and in some examples one or two hydroxyl groups are substituted by an X⁻ anion. Due to the tetra-coordinated boron atom, a fluoroboric acid group in a fluoroboric acid-functionalized polymer molecule has a negative formal charge and may be counterbalanced by a cation, such as H⁺, Li⁺, Na⁺, Al³⁺, Ni²⁺, or any other suitable cation, including cations used in battery applications. Fluoroboric acid-functionalized polymers include, without limitation, fluoroboric acid-functionalized PTFE polymers, fluoroboric acid-functionalized PCTFE polymers, fluoroboric acid-functionalized polystyrene polymers, fluoroboric acid-functionalized cellulose polymers, and fluoroboric acid-functionalized PBI polymers.

A fluoroboric acid-functionalized PTFE polymer molecule includes a PTFE main chain, a side group or side chain coupled to the PTFE main chain, and a fluoroboric acid group in or coupled to the side group or side chain. In some examples, a fluoroboric acid-functionalized PTFE polymer molecule is a derivative of a sulfonic acid-functionalized PTFE polymer molecule (e.g., a polyfluorosulfonic acid-functionalized PTFE polymer, such as a Nafion™ or Aquivion® polymer) in which one or more pendant sulfonic acid groups have been replaced by or appended with one or more fluoroboric acid groups.

A fluoroboric acid-functionalized PCTFE polymer molecule includes a PCTFE main chain, a side group or side chain coupled to the PTFE main chain (e.g., in place of a chlorine atom), and a fluoroboric acid group in or coupled to the side group or side chain). Thus, a PCTFE polymer molecule includes polymers in which one or more chlorine atoms in the PCTFE main chain have been substituted with a side chain or side group including one or more fluoroboric acid groups.

A fluoroboric acid-functionalized polystyrene polymer molecule includes a polystyrene main chain and a fluoroboric acid group coupled to the polystyrene main chain directly (e.g., to a phenyl group of the polystyrene main chain) or indirectly by way of a linker (e.g., a side group or side chain coupled to the phenyl group). In some examples, a fluoroboric acid-functionalized polystyrene polymer molecule is a derivative of a sulfonic acid-functionalized polystyrene polymer molecule (e.g., a polystyrene sulfonic acid polymer (CH₂CHC₆H₄SO₃H)ₙ) in which one or more pendant sulfonic acid groups have been replaced by or appended with one or more fluoroboric acid groups.

A fluoroboric acid-functionalized PBI polymer molecule includes a polybenzimidazole (PBI) main chain and a fluoroboric acid group coupled to the PBI main chain directly (e.g., to an aromatic group) or by way of a linker (e.g., a side group or side chain coupled to the PBI main chain). In some examples, a fluoroboric acid-functionalized PBI polymer is crosslinked with another polymer, such as another PBI polymer, a PTFE polymer, or a poly(phosphoric acid) (PPA) polymer. In some examples, the fluoroboric acid-functionalized PBI polymer comprises a PPA-doped PBI polymer (PPA-PBI).

A fluoroboric acid-functionalized cellulose polymer molecule includes a cellulosic main chain, a side group or side chain coupled to the main chain, and a fluoroboric acid group in or coupled to the side group or side chain. In some examples, a fluoroboric acid-functionalized cellulose polymer molecule is a derivative of a sulfonic acid-functionalized cellulose polymer molecule or a boronic acid-functionalized cellulose polymer molecule in which one or more pendant sulfonic acid groups or boronic acid groups have been replaced with a side chain or side group including one or more fluoroboric acid groups.

In some examples, a fluoroboric acid-functionalized polymer molecule is synthesized by performing a fluoride treatment on a boronic acid-functionalized polymer molecule. Any boronic acid-functionalized polymer molecule described herein may be used. The fluoride treatment functionalizes the boronic acid-functionalized polymer molecule at the boronic acid group with a fluoroboric acid group having a tetra-coordinated boron atom. The fluoride treatment may be performed in any suitable way.

In some examples, the fluoride treatment comprises combining a boronic acid-functionalized polymer molecule with a fluoride reagent. In some examples, the reagent compound comprises hydrogen fluoride (HF), lithium fluoride (LiF), sodium fluoride (NaF), potassium fluoride (KF), potassium bifluoride (KHF₂), cesium fluoride (CsF), ammonium fluoride (NH₄F), ammonium bifluoride (NH₄F₂), or a tetraalkylammonium fluoride (having the general formula NR₄F, wherein each R is independently hydrogen or a wholly or partly substituted or unsubstituted alkyl or aryl group having one to twenty, one to ten, one to eight, one to six, or one to four carbon atoms, such as but not limited to a methyl, ethyl, propyl, or butyl group). In some examples, the fluoride treatment is performed with two or more different fluoride reagents (e.g., HF and NaF, HF and LiF, etc.). The fluoride treatment adds a fluoride group to a pendant boronic acid group to form a fluoroboric acid group in which the boron atom is tetra-coordinated and covalently bonded to the fluoride group. Depending on the stoichiometry of the reaction, the fluoride treatment may also replace one or more hydroxyl groups of the pendant boronic acid group with a fluoride group.

The fluoride compound combines with a boronic acid group of the boronic acid-functionalized polymer molecule to form a pendant fluoroboric acid group. One or more hydroxyl groups of the boronic acid group are replaced by fluoride from the fluoride compound and a fourth fluoride group is added. Thus, the boron atom becomes tetra-coordinated so that the pendant fluoroboric acid group has a negative formal charge and is counterbalanced by a cation (e.g., H⁺, Li⁺, Na⁺, K+, Cs⁺, NH₄⁺, or NR₄⁺).

In some examples in which the counter cation is not hydrogen (e.g., when the fluoride compound is one or more of LiF, NaF, KF, KHF₂, CsF, NH₄F, NH₄F₂, or NR₄F), the fluoride treatment may be followed by a protonation step to replace the counter cation with a proton (H⁺). The protonation step may be performed in any suitable way. In some examples, the protonation step is performed by combining the fluoroboric acid-functionalized polymer molecule with a strong acid. Examples of suitable strong acids include, without limitation, hydrochloric acid (HCl), sulfuric acid (H₂SO₄), methanesulfonic acid (CH₃SO₃H), and trifluoracetic acid (CF₃CO₂H). After the protonation step, the pendant fluoroboric acid group is counterbalanced by a proton (H⁺).

In other examples of the fluoride treatment, the hydrogen atom of one or more hydroxyl groups of the pendant boronic acid group is replaced with a fluoroboric acid group. In these examples, the fluoride treatment comprises combining the boronic acid-functionalized polymer molecule with a fluoroboric compound of the formula BFₘ(OH)₍₃₋ₘ₎ where m is 1, 2, or 3 (e.g., fluorodihydroxy boric acid (BF(OH)₂), difluorohydroxy boric acid (BF₂(OH)), and/or boron trifluoride (BF₃). In further examples, the fluoride treatment may also include combining the boronic acid-functionalized polymer molecule with a boronic acid RB(OH)₂ and fluoride reagent (e.g., HF) in situ in a one-pot process, with the fluoride reagent as the limiting reagent, where R is an alkyl or aryl group (e.g., 1 to 20, 1 to 10, 1 to 8, 1 to 6, 1 to 4, or 1 to 3 carbon atoms), branched or unbranched, wholly or partly substituted or unsubstituted.

In examples where the reaction results in a tetra-coordinated boronic acid group having one or two remaining hydroxyl groups, the same reaction may be repeated or a different reaction may be performed to replace one or both of the remaining hydroxyl groups with a fluoride group or anion group X⁻, as described above. In other examples, conversion of a boronic acid group to a tetra-coordinated boronic acid group may be performed using multiple reagents in the same step (e.g., at least two of the compound XH, a fluoride reagent, a fluoroboronic compound, or a boronic acid).

Illustrative reaction schemes for synthesizing a fluoroboric acid-functionalized polymer using a boronic acid-functionalized polymer as a starting material will now be described.

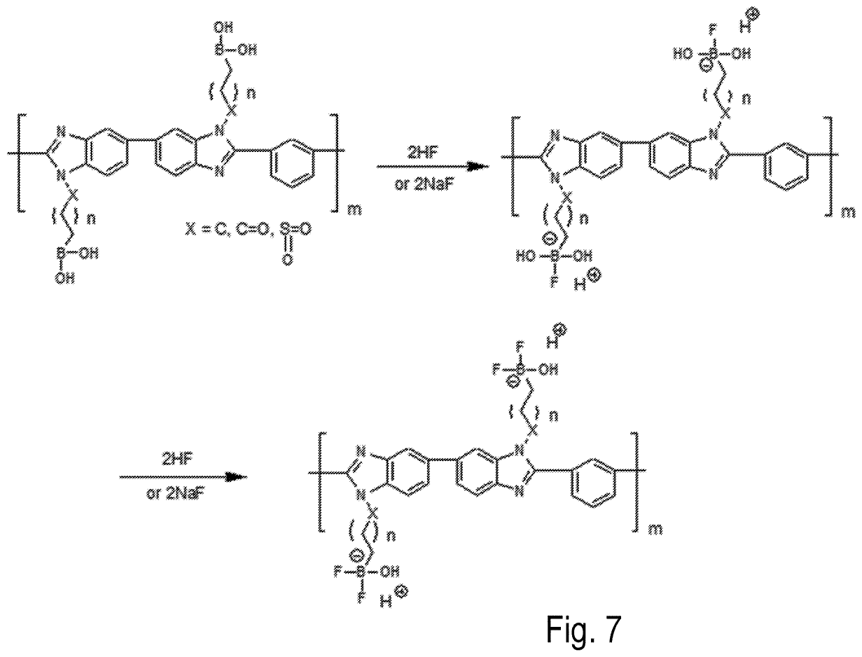

FIGS. 4A-4C show illustrative reaction schemes for synthesizing a fluoroboric acid-functionalized polymer by performing a fluoride treatment of a boronic acid-functionalized polymer. Any boronic acid-functionalized polymer described herein may be used, including but not limited to a boronic acid-functionalized PBI polymer, a boronic acid-functionalized PTFE polymer, or a boronic acid-functionalized polystyrene polymer.

In the example of FIG. 4A, the fluoride treatment comprises combining the boronic acid-functionalized polymer molecule with hydrogen fluoride or sodium fluoride as the fluoride reagent. The fluoride groups of the fluoride reagent replace the hydroxyl groups of the boronic acid group. The resulting product is a fluoroboric acid-functionalized polymer molecule having a pendant fluoroboric acid group. The fluoroboric acid group has a tetra-coordinated boron atom covalently bonded to the main chain or a side chain or side group and to three fluorine atoms. Thus, the fluoroboric acid group has a negative formal charge and is intrinsically ionic and acidic and is counterbalanced by a cation derived from the fluoride reagent. Where the fluoride reagent is HF, the cation is a proton. Where the fluoride reagent is NaF (or any other fluoride reagent), a protonation step is performed after the fluoride treatment to replace the counter cation with a proton. However, in some examples the protonation step is omitted so that the fluoroboric acid group is counterbalanced by the cation derived from the fluoride reagent.

The degree of fluoride loading on boronic acid groups and on the boronic acid-functionalized polymer molecule, and thus the pKa of the resulting fluoroboric acid-functionalized polymer, may be tuned as desired based on the stoichiometry of the reagents. Fluorine is the most electronegative element, and thus the acidity of fluoroboric acid increases with the increased number of fluorine atoms covalently bonded to the boron atom. As shown in the example of FIG. 4A, the molar ratio of the fluoride reagent to boronic acid groups is three or more to one (z 3:1), resulting in a trifluoroboric acid group. The presence of three fluorine atoms covalently bonded to the tetra-coordinated boron atom in the resulting polymer structure makes trifluoroboric acid the most acidic fluoroboric acid (the lowest pKa). Thus, by the reaction scheme of FIG. 4A, the boronic acid-functionalized polymer may be converted into a superacid and strong proton-conducting fluoroboric acid-functionalized polymer that is intrinsically ionic with tetra-coordinated anionic boron atoms.

The versatile chemistry of the fluoride treatment process enables synthesis of less acidic fluoroboric acid groups than the trifluoroboric acid group of FIG. 4A. For example, the molar ratio of the fluoride reagent (e.g., HF) to the boronic acid group may be less than 3:1, such that the fluoride reagent is the limiting reagent. The pKa of the resulting fluoroboric acids will be higher (less acidic) than the super acidic trifluoro boric acid and lower (more acidic) than the weakly acidic boronic acid group of the starting boronic acid-functionalized polymer molecule. The pKa can be controlled to a desired level for many applications, including electrochemical processes for ammonia production. For instance, when the molar ratio of the fluoride reagent to the boronic acid group is approximately 1:1, one fluorine atom covalently bonds to the boron atom, as shown in the reaction scheme of FIG. 4B. When the molar ratio of the fluoride reagent to the boronic acid group is approximately 2:2, two fluorine atoms covalently bond to the boron atom, as shown in the reaction scheme of FIG. 4C. Any suitable molar ratio of the fluoride reagent to the boronic acid group may be used, such as 3:1 or greater, 2.5:1, 2:1, 1.5:1, 1:1, 0.5:1, or any other suitable ratio.

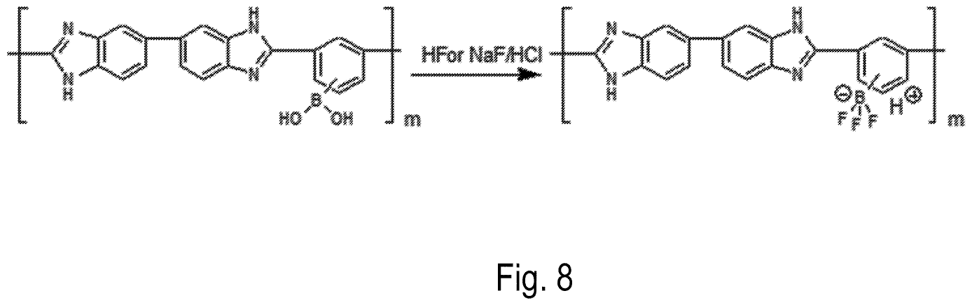

FIGS. 5A and 5B show alternative illustrative reaction schemes for synthesizing a fluoroboric acid-functionalized polymer by performing a fluoride treatment of a boronic acid-functionalized polymer. Any boronic acid-functionalized polymer described herein may be used, including but not limited to a boronic acid-functionalized PBI polymer, a boronic acid-functionalized PTFE polymer, or a boronic acid-functionalized polystyrene polymer.

In the example of FIG. 5A, the fluoride treatment comprises combining the boronic acid-functionalized polymer molecule with boron trifluoride (BF₃) to yield a super proton-conducting dibasic fluoroboric acid-functionalized polymer molecule. Boron trifluoride may be used in its diethyl ether and/or tetrahydrofuran complexes. A fluoroboric acid group replaces a hydrogen atom of both hydroxyl groups of the boronic acid group. The presence of three fluorine atoms covalently bonded to the tetra-coordinated boron atom in the resulting polymer structure makes it a super acidic fluoroboric acid. Thus, the boronic acid group is converted into a super proton-conducting dibasic acid using boron trifluoride. The dibasic acid has twice the ion exchange capacity (IEC) compared to monobasic acids. Higher IEC increases proton conductivity, thereby increasing the efficiency of an ionomer and PEM. The additional fluorine atoms also help modulate the hydrophobic-hydrophilic balance and the hydrogen bond networks in the polymers, thereby further facilitating proton transport.

The degree of fluoride loading on the boronic acid group and on the boronic acid-functionalized polymer, and thus the pKa of the resulting fluoroboric acid-functionalized polymer, may be tuned as desired based on the stoichiometry of the reagents. As shown in the example of FIG. 5A, the molar ratio of boron trifluoride to boronic acid groups is two or more to one (≥2:1). The presence of three fluorine atoms covalently bonded to the tetravalent boron atom in the resulting polymer structure makes it the most acidic fluoroboric acid (the lowest pKa). Thus, by the reaction scheme of FIG. 5A, the boronic acid-functionalized polymer may be converted into a superacid and strong proton-conducting fluoroboric acid-functionalized polymer that is intrinsically ionic with tetra-coordinated anionic boron atoms.

The versatile chemistry of the fluoride treatment enables synthesis of a less acidic fluoroboric acid-functionalized polymer than the trifluoroboric acid-functionalized polymer of FIG. 5A. For example, the molar ratio of boron trifluoride to boronic acid groups may be less than 2:1, such that boron trifluoride is the limiting reagent, resulting in a product with an intermediate pKa. When the molar ratio of boron trifluoride to boronic acid groups is approximately 1:1, only one hydrogen atom of a boronic acid group is substituted with a fluoroboric acid group, as shown in FIG. 5B. The pKa can be controlled to a desired level by using any suitable molar ratio of boron trifluoride to boronic acid groups, such as 2:1 or greater, 1.5:1, 1:1, 0.5:1, or any other suitable ratio.

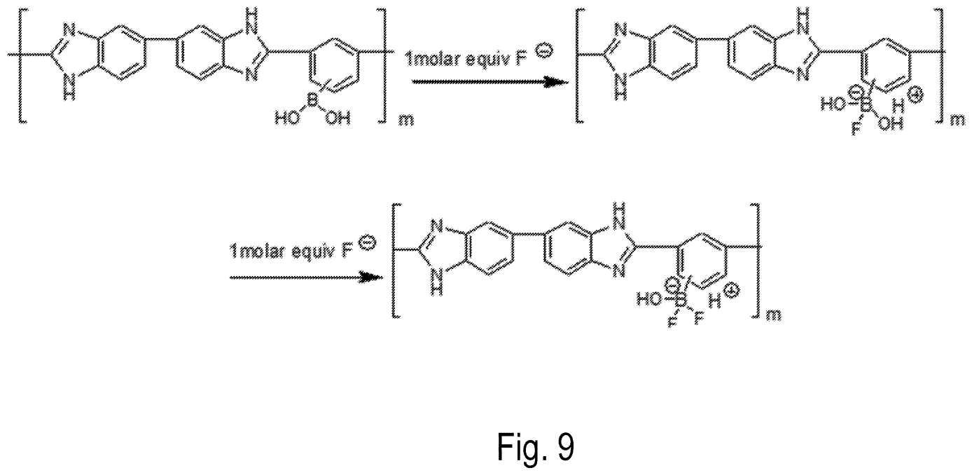

FIGS. 6 and 7 show illustrative reaction schemes for synthesizing a fluoroboric acid-functionalized PBI polymer by performing a fluoride treatment of a boronic acid-functionalized PBI polymer. In the example of FIG. 6, the fluoride treatment comprises combining the boronic acid-functionalized polymer molecule with hydrogen fluoride or sodium fluoride as the fluoride reagent. The fluoride groups of the fluoride reagent replace the hydroxyl groups of the boronic acid group. The resulting product is a fluoroboric acid-functionalized polymer molecule having a pendant trifluoroboric acid group. The trifluoroboric acid group has a tetra-coordinated boron atom covalently bonded to a side chain and to three fluorine atoms. Thus, the fluoroboric acid group has a negative formal charge and is intrinsically ionic and acidic and is counterbalanced by a cation.

The degree of fluoride loading on boronic acid groups and on the boronic acid-functionalized PBI polymer, and thus the pKa of the resulting fluoroboric acid-functionalized PBI polymer, may be tuned as desired based on the stoichiometry of the reagents. As shown in the example of FIG. 6, the molar ratio of HF or NaF to boronic acid groups is equal to or greater than about 6:1, whether in one step or in multiple stages, resulting in a trifluoroboric acid group in place of each boronic acid group.

In other examples, HF is the limiting reagent so that the pKa of the resulting fluoroboric acids will be higher (less acidic) than the super acidic trifluoroboric acid of FIG. 6 and lower (more acidic) than the weakly acidic boronic acid group of the starting boronic acid-functionalized PBI polymer. For instance, when the molar ratio of the fluoride reagent to boronic acid groups is approximately 2:1, one fluorine atom covalently bonds to each boron atom of the boronic acid groups linked to the PBI repeating unit, as shown in the reaction scheme of FIG. 7. When the molar ratio of the fluoride reagent to boronic acid groups is approximately 4:2, or another stage of the fluoride treatment is performed, another fluorine atom covalently bonds to each boron atom. Any suitable molar ratio of the fluoride reagent to boronic acid groups may be used, such as 6:1 or greater, 5:1, 4:1, 3:1, 2:1, 1:1, or any other suitable ratio.

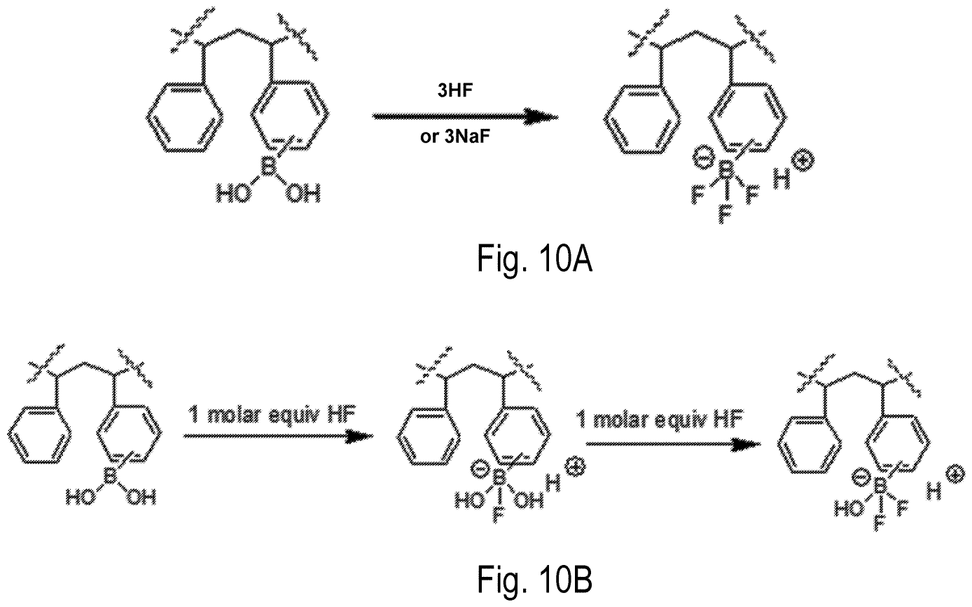

FIGS. 8 and 9 show alternative illustrative reaction schemes for synthesizing a fluoroboric acid-functionalized PBI polymer by performing a fluoride treatment of a boronic acid-functionalized PBI polymer. The reaction scheme of FIG. 8 is similar to the reaction schemes of FIGS. 6 and 7 except that, in the reaction scheme of FIG. 8, the boronic acid group is linked directly to an aromatic group in the PBI repeating unit. In the example of FIG. 8, the fluoride treatment comprises combining the boronic acid-functionalized polymer molecule with hydrogen fluoride or sodium fluoride as the fluoride reagent (followed by protonation with HCl). The fluoride groups of the fluoride reagent replace the hydroxyl groups of the boronic acid group. The resulting product is a fluoroboric acid-functionalized polymer molecule having a pendant trifluoroboric acid group. The trifluoroboric acid group has a tetra-coordinated boron atom covalently bonded to a side chain and to three fluorine atoms. Thus, the fluoroboric acid group has a negative formal charge and is intrinsically ionic and acidic and is counterbalanced by a cation.

The degree of fluoride loading on boronic acid groups and on the boronic acid-functionalized PBI polymer, and thus the pKa of the resulting fluoroboric acid-functionalized PBI polymer, may be tuned as desired based on the stoichiometry of the reagents. As shown in the example of FIG. 8, the molar ratio of HF or NaF to boronic acid groups is equal to or greater than about 3:1, resulting in a trifluoroboric acid group.

In other examples, the fluoride reagent is the limiting reagent so that the pKa of the resulting fluoroboric acids will be higher (less acidic) than the super acidic trifluoroboric acid of FIG. 8 and lower (more acidic) than the weakly acidic boronic acid group of the starting boronic acid-functionalized PBI polymer. For instance, when the molar ratio of the fluoride reagent to boronic acid groups is approximately 1:1, one fluorine atom covalently bonds to the boron atom of the boronic acid group, as shown in the reaction scheme of FIG. 9. When the molar ratio of the fluoride reagent to boronic acid groups is approximately 2:2, or another stage of the fluoride treatment is performed, another fluorine atom covalently bonds to the boron atom. Any suitable molar ratio of the fluoride reagent to boronic acid groups may be used, such as 3:1 or greater, 2.5:1, 2:1, 1.5:1, 1:1, 0.5:1, or any other suitable ratio.

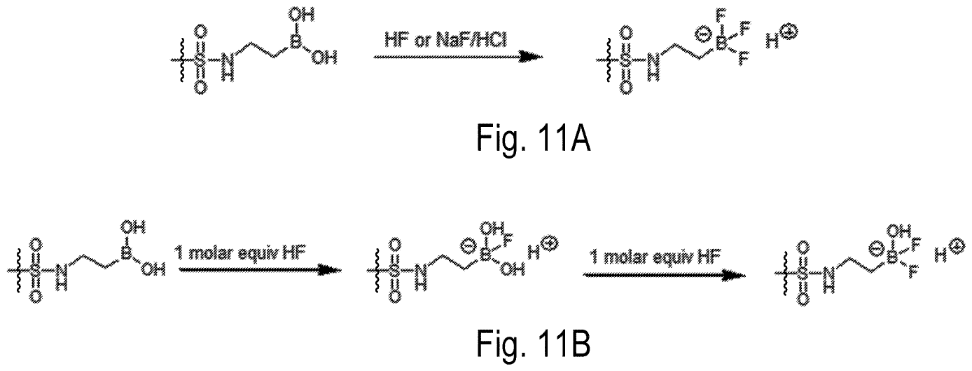

FIGS. 10A and 10B show illustrative reaction schemes for synthesizing a fluoroboric acid-functionalized polystyrene polymer by performing a fluoride treatment of a boronic acid-functionalized polystyrene polymer. In the example of FIG. 10A, the fluoride treatment comprises combining the boronic acid-functionalized polystyrene polymer molecule with hydrogen fluoride or sodium fluoride as the fluoride reagent. The fluoride groups of the fluoride reagent replace the hydroxyl groups of the boronic acid group. The resulting product is a fluoroboric acid-functionalized polymer molecule having a pendant trifluoroboric acid group. The trifluoroboric acid group has a tetra-coordinated boron atom covalently bonded to a side chain and to three fluorine atoms. Thus, the fluoroboric acid group has a negative formal charge and is intrinsically ionic and acidic and is counterbalanced by a cation.

The degree of fluoride loading on boronic acid groups and on the boronic acid-functionalized polystyrene polymer, and thus the pKa of the resulting fluoroboric acid-functionalized polystyrene polymer, may be tuned as desired based on the stoichiometry of the reagents. As shown in the example of FIG. 10A, the molar ratio of HF or NaF to boronic acid groups is equal to or greater than about 3:1, resulting in a trifluoroboric acid group.

In other examples, the fluoride reagent is the limiting reagent so that the pKa of the resulting fluoroboric acids will be higher (less acidic) than the super acidic trifluoroboric acid of FIG. 10A and lower (more acidic) than the weakly acidic boronic acid group of the starting boronic acid-functionalized polystyrene polymer. For instance, when the molar ratio of the fluoride reagent to boronic acid groups is approximately 1:1, one fluorine atom covalently bonds to the boron atom of the boronic acid group, as shown in the reaction scheme of FIG. 10B. When the molar ratio of the fluoride reagent to boronic acid groups is approximately 2:2, or another stage of the fluoride treatment is performed, another fluorine atom covalently bonds to the boron atom. Any suitable molar ratio of the fluoride reagent to boronic acid groups may be used, such as 3:1 or greater, 2.5:1, 2:1, 1.5:1, 1:1, 0.5:1, or any other suitable ratio.

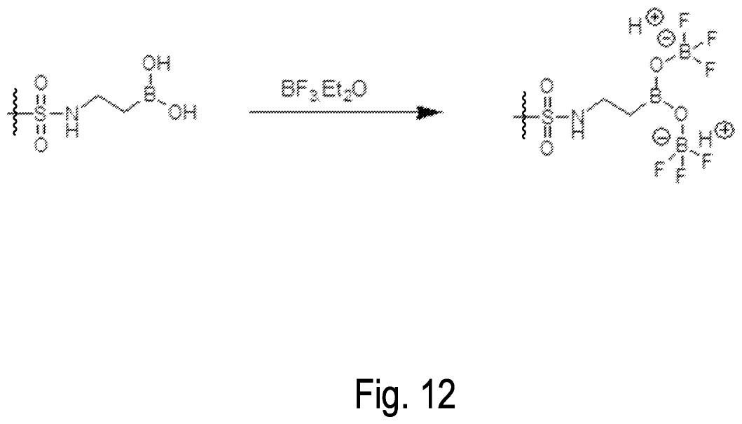

FIGS. 11A and 11B show illustrative reaction schemes for synthesizing a fluoroboric acid-functionalized polymer by performing a fluoride treatment of a boronic acid-functionalized polymer. In the example of FIG. 11A, the fluoride treatment comprises combining a boronic acid-functionalized polymer molecule with hydrogen fluoride or sodium fluoride as the fluoride reagent. The boronic acid-functionalized polymer molecule is a derivative of a sulfonic acid-functionalized polymer molecule having a boronic acid group in place of a sulfonic acid group. The boronic acid group is linked to a main chain by a linker through a sulfonamide link. The fluoride groups of the fluoride reagent replace the hydroxyl groups of the boronic acid group. The resulting product is a fluoroboric acid-functionalized polymer molecule having a pendant trifluoroboric acid group linked to the main chain by a linker through a sulfonamide link. The trifluoroboric acid group has a tetra-coordinated boron atom covalently bonded to a side chain and to three fluorine atoms. Thus, the fluoroboric acid group has a negative formal charge and is intrinsically ionic and acidic and is counterbalanced by a cation.

The degree of fluoride loading on boronic acid groups and on the boronic acid-functionalized polymer, and thus the pKa of the resulting fluoroboric acid-functionalized polymer, may be tuned as desired based on the stoichiometry of the reagents. As shown in the example of FIG. 11A, the molar ratio of HF or NaF to boronic acid groups is equal to or greater than about 3:1, resulting in a trifluoroboric acid group.

In other examples, the fluoride reagent is the limiting reagent so that the pKa of the resulting fluoroboric acids will be higher (less acidic) than the super acidic trifluoroboric acid of FIG. 11A and lower (more acidic) than the weakly acidic boronic acid group of the starting boronic acid-functionalized polystyrene polymer. For instance, when the molar ratio of the fluoride reagent to boronic acid groups is approximately 1:1, one fluorine atom covalently bonds to the boron atom of the boronic acid group, as shown in the reaction scheme of FIG. 11B. When the molar ratio of the fluoride reagent to boronic acid groups is approximately 2:2, or another stage of the fluoride treatment is performed as shown in FIG. 11B, another fluorine atom covalently bonds to the boron atom. Any suitable molar ratio of the fluoride reagent to boronic acid groups may be used, such as 3:1 or greater, 2.5:1, 2:1, 1.5:1, 1:1, 0.5:1, or any other suitable ratio.

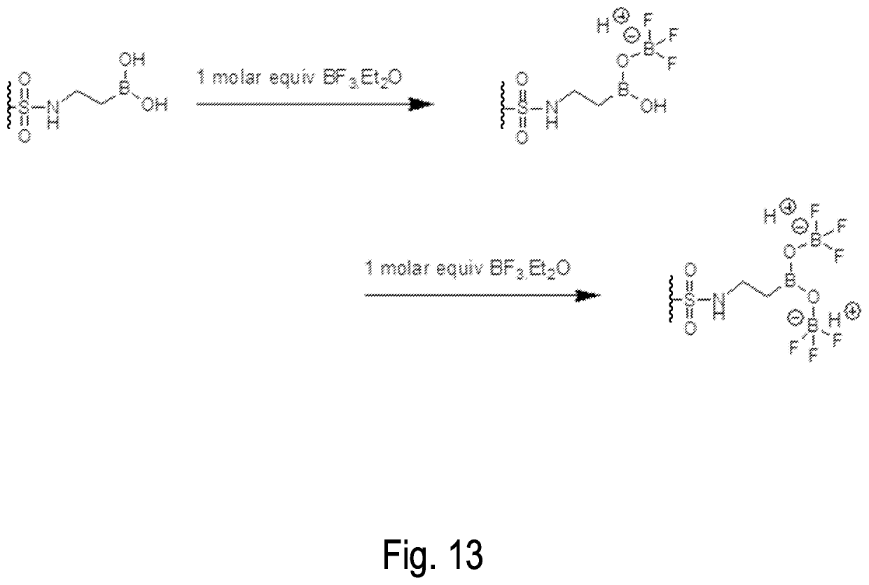

FIGS. 12 and 13 show alternative illustrative reaction schemes for synthesizing a fluoroboric acid-functionalized polymer by performing a fluoride treatment of a boronic acid-functionalized polymer. In the example of FIG. 12, the boronic acid-functionalized polymer is a derivative of a sulfonic acid-functionalized polymer having a boronic acid group linked to the main chain by a linker through a sulfonamide link. However, any other boronic acid-functionalized polymer may be used, including but not limited to a boronic acid-functionalized PBI polymer, a boronic acid-functionalized PTFE polymer, a boronic acid-functionalized PCTFE polymer, or a boronic acid-functionalized polystyrene polymer.

In the example of FIG. 12, the fluoride treatment comprises combining the boronic acid-functionalized polymer molecule with boron trifluoride (BF₃) to yield a super proton-conducting dibasic fluoroboric acid-functionalized polymer molecule. Boron trifluoride may be used in its diethyl ether and/or tetrahydrofuran complexes. A trifluoroboric acid group replaces a hydrogen atom of both hydroxyl groups of the boronic acid group. The presence of three fluorine atoms covalently bonded to the tetra-coordinated boron atom in the resulting polymer structure makes it a super acidic fluoroboric acid. Thus, the boronic acid group is converted into a super proton-conducting dibasic acid using boron trifluoride. The dibasic acid has twice the ion exchange capacity compared to monobasic acids.

The degree of fluoride loading on boronic acid groups and on the boronic acid-functionalized polymer, and thus the pKa of the resulting fluoroboric acid-functionalized polymer, may be tuned as desired based on the stoichiometry of the reagents. As shown in the example of FIG. 12, the molar ratio of BF₃ to boronic acid groups is equal to or greater than about 2:1, resulting in two trifluoroboric acid groups.

In other examples, BF₃ is the limiting reagent so that the pKa of the resulting fluoroboric acids will be higher (less acidic) than the super acidic trifluoroboric acid of FIG. 12 and lower (more acidic) than the weakly acidic boronic acid group of the starting boronic acid-functionalized polystyrene polymer. For instance, when the molar ratio of BF₃ to boronic acid groups is approximately 1:1, one trifluoroboric group covalently bonds to an oxygen atom of the boronic acid group, as shown in the reaction scheme of FIG. 13. When the molar ratio of BF₃ to boronic acid groups is approximately 2:2, or another stage of the fluoride treatment is performed as shown in FIG. 13, another trifluoroboric acid group covalently bonds to the other oxygen atom of the boronic acid group. Any suitable molar ratio of BF₃ to boronic acid groups may be used, such as 2:1 or greater, 1.5:1, 1:1, 0.5:1, or any other suitable ratio.

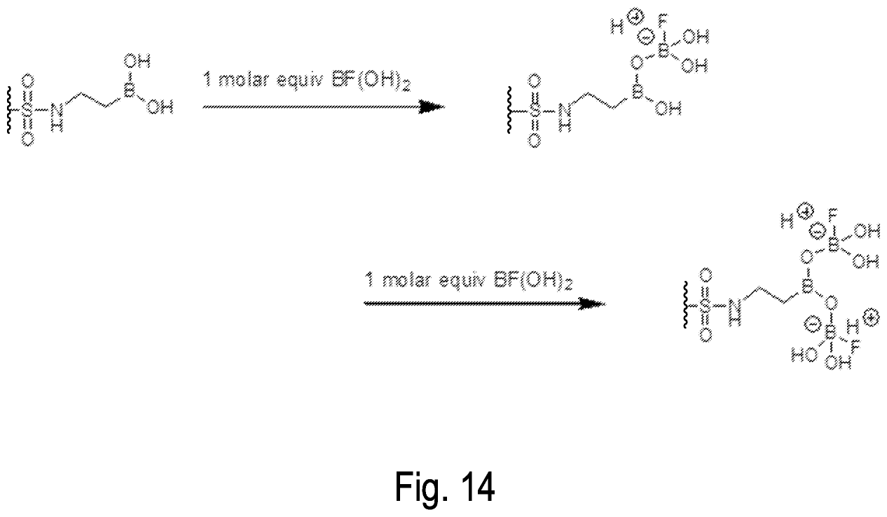

FIG. 14 shows another illustrative reaction scheme for synthesizing a fluoroboric acid-functionalized polymer. As shown, the boronic acid-functionalized polymer is a derivative of a sulfonic acid-functionalized polymer. However, any other boronic acid-functionalized polymer may be used, including but not limited to a boronic acid-functionalized PBI polymer, a boronic acid-functionalized PTFE polymer, or a boronic acid-functionalized polystyrene polymer.

In the example of FIG. 14, the boronic acid-functionalized polymer molecule is combined with a fluoroboric acid (BF(OH)₂) to yield a fluoroboric acid-functionalized polymer molecule. A fluoroboric acid group replaces a hydrogen atom of one or both hydroxyl groups of the boronic acid group, depending on the reaction stoichiometry. The presence of the fluorine atom covalently bonded to the tetra-coordinated boron atom in the resulting polymer structure results in an acidic fluoroboric acid group. Thus, the boronic acid group of the starting polymer molecule is converted into a proton-conducting fluoroboric acid group using a fluoroboric acid reagent. In other examples, the fluoroboric acid reagent has the formula BF₂(OH) or RBF(OH) where R is an alkyl or aryl group.

The degree of fluoride loading on the boronic acid-functionalized polymer, and thus the pKa of the resulting fluoroboric acid-functionalized polymer, may be tuned as desired based on the type and stoichiometry of the reagents.

The tetra-coordinated boronic acid-functionalized polymers described herein, including fluoroboric acid-functionalized polymers, may be used in proton exchange membranes and ionomers for water electrolysis and fuel cell applications.

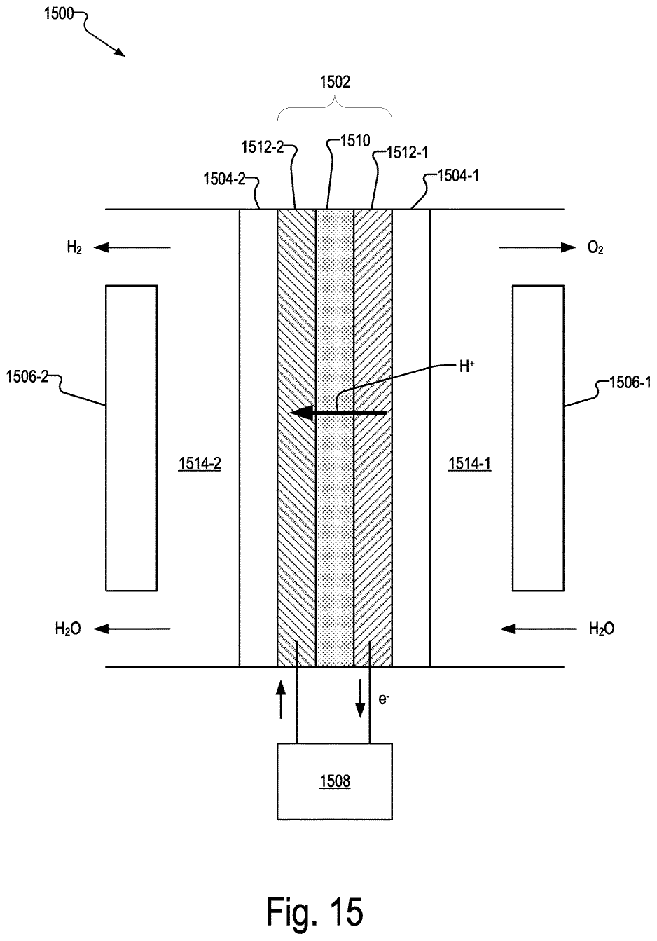

FIG. 15 shows an illustrative proton exchange membrane water electrolysis system 1500 (PEM water electrolysis system 1500) incorporating tetra-coordinated boronic acid-functionalized polymer PEMs and/or ionomers. PEM water electrolysis system 1500 uses electricity to split water into oxygen (O₂) and hydrogen (H₂) via an electrochemical reaction. The configuration of PEM water electrolysis system 1500 is merely illustrative and not limiting, as other suitable configurations as well as other suitable water electrolysis systems may incorporate tetra-coordinated boronic acid-functionalized polymers.

As shown in FIG. 15, PEM water electrolysis system 1500 includes a membrane electrode assembly 1502 (MEA 1502), porous transport layers 1504-1 and 1504-2 (e.g., gas diffusion layers), bipolar plates 1506-1 and 1506-2, and an electrical power supply 1508. PEM water electrolysis system 1500 may also include additional or alternative components not shown in FIG. 15 as may serve a particular implementation.

MEA 1502 includes a PEM 1510 positioned between a first catalyst layer 1512-1 and a second catalyst layer 1512-2. PEM 1510 electrically isolates first catalyst layer 1512-1 from second catalyst layer 1512-2 while providing selective conductivity of cations, such as protons (H′), and while being impermeable to gases such as hydrogen and oxygen. PEM 1510 may be implemented by a tetra-coordinated boronic acid-functionalized polymer (e.g., a fluoroboric acid-functionalized polymer) as described herein, or by any other suitable polymer.

First catalyst layer 1512-1 and second catalyst layer 1512-2 are electrically conductive electrodes that include catalyst solid supports bound with electrocatalyst particles (not shown), such as platinum group metals, metal alloys, and/or metal oxides. First catalyst layer 1512-1 and second catalyst layer 1512-2 may also include one or more ionomers mixed with the catalyst solid supports and electrochemical catalyst particles. The ionomers may be implemented by a tetra-coordinated boronic acid-functionalized polymer (e.g., a fluoroboric acid-functionalized polymer) as described herein, or by any other suitable ionomer.

MEA 1502 is placed between porous transport layers 1504-1 and 1504-2, which are in turn placed between bipolar plates 1506-1 and 1506-2 with flow channels 1514-1 and 1514-2 located in between bipolar plates 1506 and porous transport layers 1504.

In MEA 1502, first catalyst layer 1512-1 functions as an anode and second catalyst layer 1512-2 functions as a cathode. When PEM water electrolysis system 1500 is powered by power supply 1508, an oxygen evolution reaction (OER) occurs at first catalyst layer/anode 1512-1, facilitated by the electrocatalysts bound to the catalyst solid supports in first catalyst layer/anode 1512-1. The OER is represented by the following electrochemical half-reaction:

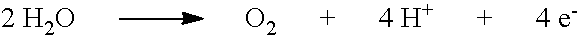

Protons are conducted from first catalyst layer/anode 1512-1 to second catalyst layer/cathode 1512-2 through PEM 1510, and electrons are conducted from first catalyst layer/anode 1512-1 to second catalyst layer/cathode 1512-2 by conductive path around PEM 1510. PEM 1510 allows for the transport of protons (H⁺) and water from the first catalyst layer/anode 1512-1 to the second catalyst layer/cathode 1512-2 but is impermeable to oxygen and hydrogen. At second catalyst layer/cathode 1512-2, the protons combine with the electrons in a hydrogen evolution reaction (HER), facilitated by the electrocatalysts bound to the catalyst solid supports in second catalyst layer/anode 1512-2. The HER is represented by the following electrochemical half-reaction:

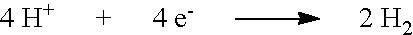

The OER and HER are two complementary electrochemical reactions for splitting water by electrolysis, represented by the following overall water electrolysis reaction:

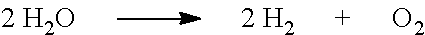

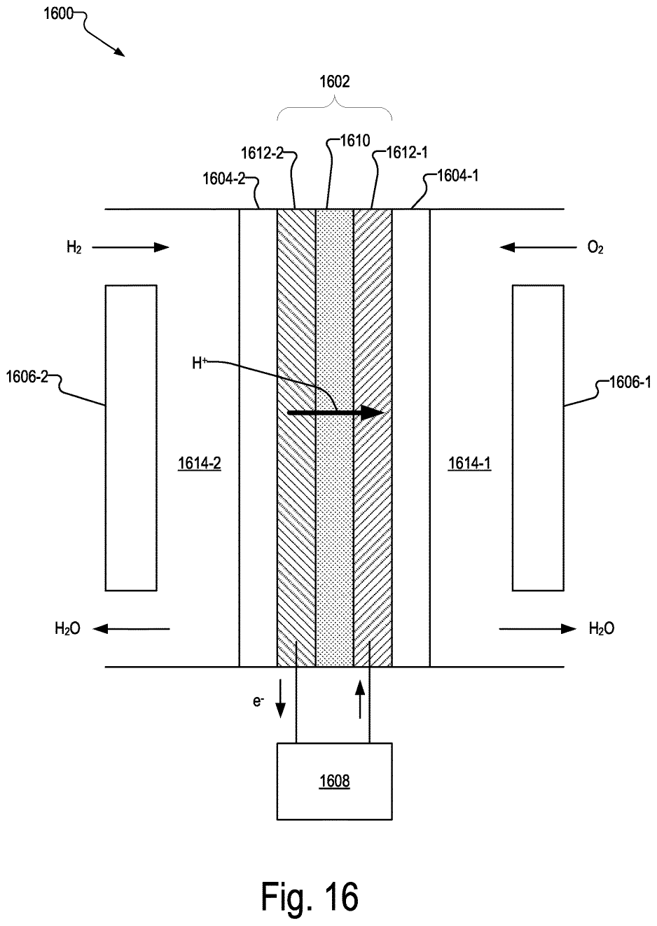

FIG. 16 shows an illustrative proton exchange membrane fuel cell 1600 (PEM fuel cell 1600) including tetra-coordinated boronic acid-functionalized polymer PEMs and/or ionomers (e.g., fluoroboric acid-functionalized polymer PEMs and/or ionomers). PEM fuel cell 1600 produces electricity as a result of electrochemical reactions. In this example, the electrochemical reactions involve reacting hydrogen gas (H₂) and oxygen gas (O₂) to produce water and electricity. The configuration of PEM fuel cell 1600 is merely illustrative and not limiting.

As shown in FIG. 16, PEM fuel cell 1600 includes a membrane electrode assembly 1602 (MEA 1602), porous transport layers 1604-1 and 1604-2 (e.g., gas diffusion layers), bipolar plates 1606-1 and 1606-2. An electrical load 1608 may be electrically connected to MEA 1602 and driven by PEM fuel cell 1600. PEM fuel cell 1600 may also include additional or alternative components not shown in FIG. 16 as may serve a particular implementation.

MEA 1602 includes a PEM 1610 positioned between a first catalyst layer 1612-1 and a second catalyst layer 1612-2. PEM 1610 electrically isolates first catalyst layer 1612-1 from second catalyst layer 1612-2 while providing selective conductivity of cations, such as protons (H⁺), and while being impermeable to gases such as hydrogen and oxygen. PEM 1610 may be implemented by any suitable PEM described herein.

First catalyst layer 1612-1 and second catalyst layer 1612-2 are electrically conductive electrodes that include catalyst solid supports that bind electrocatalyst particles (not shown), such as platinum metals, metal alloys, and/or metal oxides. First catalyst layer 1612-1 and second catalyst layer 1612-2 may also include one or more ionomers mixed with the catalyst solid supports and electrochemical catalyst particles. The ionomers may be implemented by any suitable polymers or ionomers described herein, including any tetra-coordinated boronic acid-functionalized polymers described herein, or by any other suitable ionomers.

MEA 1602 is placed between porous transport layers 1604-1 and 1604-2, which are in turn placed between bipolar plates 1606-1 and 1606-2 with flow channels 1614 located in between. In MEA 1602, first catalyst layer 1612-1 functions as a cathode and second catalyst layer 1612-2 functions as an anode. First catalyst layer/cathode 1612-1 and anode 1612-2 are electrically connected to load 1608, and electricity generated by PEM fuel cell 1600 drives load 1608.

During operation of PEM fuel cell 1600, hydrogen gas (H₂) flows into the anode side of PEM fuel cell 1600 and oxygen gas (O₂) flows into the cathode side of PEM fuel cell 1600. At second catalyst layer/anode 1612-2, hydrogen molecules are catalytically split into protons (H⁺) and electrons (e⁻) according to the following hydrogen oxidation reaction (HOR), which is facilitated by the electrocatalysts particles bound to the catalyst solid supports in second catalyst layer/anode 1612-2:

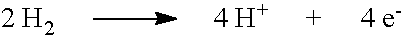

The protons are conducted from anode 1612-2 to first catalyst layer/cathode 1612-1 through PEM 1600, and the electrons are conducted from second catalyst layer/anode 1612-2 to first catalyst layer/cathode 1612-1 around PEM 1610 through a conductive path and load 1608. At first catalyst layer/cathode 1612-1, the protons and electrons combine with the oxygen gas according to the following oxygen reduction reaction (ORR), which is facilitated by the electrochemical catalysts particles bound to the catalyst solid supports in first catalyst layer/anode 1612-1:

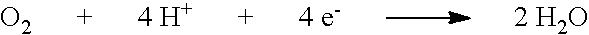

Thus, the overall electrochemical reaction for the PEM fuel cell 1600 is:

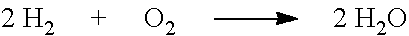

In the overall reaction, PEM fuel cell 1600 produces water at first catalyst layer/cathode 1612-1. Water may flow from first catalyst layer/cathode 1612-1 to second catalyst layer/anode 1612-2 through PEM 1610 and may be removed through outlets at the cathode side and/or anode side of PEM fuel cell 1600. The overall reaction generates electrons at the anode that drive load 1608.

In the examples of FIGS. 14 and 15, MEA 1502 and MEA 1602 include catalyst layers 1512/412 formed on PEM 1510/410. In alternative configurations, catalyst layers 1512/412 may be coated on PEM 110/410 to thereby form a catalyst coated membrane (CCM). For example, catalyst layers 1512/212 may be formed in a one-pot process or in stages and sprayed onto PEM 1510/410.

Various examples and embodiments have been described and illustrated herein. It will, however, be evident that various modifications and changes may be made thereto, and additional embodiments may be implemented, without departing from the scope of the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following examples:

Example 1. A method of making a tetra-coordinated boronic acid-functionalized polymer molecule, comprising: reacting a pendant boronic acid group of a boronic acid-functionalized polymer molecule with a fluoride reagent and/or a compound having the general formula HX, wherein HX is a Brønsted-Lowry acid.

Example 2. The method of example 1, wherein the boronic acid-functionalized polymer molecule comprises a boronic acid-functionalized polybenzimidazole (PBI) polymer molecule.

Example 3. The method of example 1, wherein the boronic acid-functionalized polymer molecule comprises a boronic acid-functionalized aromatic polymer molecule.

Example 4. The method of example 1, wherein the boronic acid-functionalized polymer molecule comprises a boronic acid-functionalized PTFE polymer molecule.

Example 5. The method of example 1, wherein the boronic acid-functionalized polymer molecule comprises a boronic acid-functionalized PCTFE polymer molecule.

Example 6. The method of example 1, wherein the boronic acid-functionalized polymer molecule comprises a boronic acid-functionalized cellulose polymer molecule.

Example 7. The method of any of the preceding examples, wherein: the method comprises reacting the pendant boronic acid group with the fluoride reagent; and the fluoride reagent comprises hydrogen fluoride (HF), lithium fluoride (LiF), sodium fluoride (NaF), potassium fluoride (KF), potassium bifluoride (KHF₂), cesium fluoride (CsF), ammonium fluoride (NH₄F), ammonium bifluoride (NH₄F₂), or a tetraalkylammonium fluoride having the general formula NR₄F, wherein each R is independently hydrogen or a substituted or unsubstituted alkyl or aryl group.

Example 8. The method of example 7, wherein: the method comprises reacting the pendant boronic acid group with the fluoride reagent; and the fluoride reagent comprises boron trifluoride.

Example 9. The method of any of the preceding examples, wherein the method comprises reacting the pendant boronic acid group with the Brønsted-Lowry acid and the Brønsted-Lowry acid comprises an alkylsulfonic acid, an arylsulfonic acid, or an alkylarylsulfonic acid.

Example 10. The method of any of the preceding examples, wherein the method comprises reacting the pendant boronic acid group with the Brønsted-Lowry acid and the Brønsted-Lowry acid comprises sulfuric acid or a derivative thereof.

Example 11. The method of any of the preceding examples, wherein the method comprises reacting the pendant boronic acid group with the Brønsted-Lowry acid and the Brønsted-Lowry acid comprises a phosphoric acid, a phosphinic acid, or a derivative thereof.

Example 12. The method of any of the preceding examples, wherein the method comprises reacting the pendant boronic acid group with the Brønsted-Lowry acid and the Brønsted-Lowry acid comprises a carboxylic acid, a phenol, or a derivative thereof.

Example 13. The method of any of the preceding examples, further comprising making the boronic acid-functionalized polymer molecule.

Example 14. The method of example 13, wherein the making the boronic acid-functionalized polymer molecule comprises functionalizing a polymer molecule with a boronic acid group.

Example 15. The method of example 14, wherein the polymer molecule comprises a PBI polymer.

Example 16. The method of example 14, wherein the polymer molecule comprises an aromatic polymer molecule.

Example 17. The method of example 14, wherein the polymer molecule comprises a PTFE polymer molecule.

Example 18. The method of example 14, wherein the polymer molecule comprises a PCTFE polymer molecule.

Example 19. The method of example 14, wherein the polymer molecule comprises a cellulose polymer molecule.

Example 20. The method of example 14, wherein the polymer molecule comprises a sulfonic acid-functionalized polymer molecule.

Example 21. The method of example 14, wherein the functionalizing the polymer molecule with the boronic acid group comprises borylating an aromatic ring in a repeating unit of the main chain.

Example 22. The method of example 21, wherein the polymer molecule comprises a PBI polymer molecule or a polystyrene polymer molecule.

Example 23. The method of example 14, wherein the functionalizing the polymer molecule with the boronic acid group comprises linking a boronic acid functionalized linker with a secondary nitrogen in a repeating unit of the main chain.

Example 24. The method of example 23, wherein the secondary nitrogen is included in a benzimidazole unit of the main chain.

Example 25. The method of any of examples 14-24, wherein the functionalizing the polymer moleculre with the boronic acid group comprises: activating a sulfonic acid group of a sulfonic acid functionalized polymer moleculre to a sulfonyl chloride, sulfonyl fluoride, or sulfonyl ester; and linking an amino group of an amino boronic acid linker with the sulfonyl chloride, sulfonyl fluoride, or sulfonyl ester.

Example 26. The method of any of examples 14-25, wherein the functionalizing the polymer moleculre with the boronic acid group comprises: activating a sulfonic acid group of a sulfonic acid functionalized polymer moleculre to a sulfonyl chloride, sulfonyl fluoride, or sulfonyl ester; linking an aromatic boronic acid with the sulfonyl chloride, sulfonyl fluoride, or sulfonyl ester; and protonating the aromatic boronic acid.

Example 27. A tetra-coordinated boronic acid-functionalized polymer molecule comprising: a main chain; and a tetra-coordinated boronic acid group linked to the main chain, the tetra-coordinated boronic acid group having the general formula —BFₘXₙ(OH)₍₃₋ₘ₋ₙ₎ where B has four covalent bonds and is covalently bonded to a polymer main chain, side chain, or side group; m and n are each independently 0, 1, 2, or 3; the sum of m+n is 1, 2, or 3; and X is an anion other than fluoride.

Example 28. The tetra-coordinated boronic acid-functionalized polymer molecule of example 27, wherein the tetra-coordinated boronic acid comprises a fluoroboric acid group where m is 1, 2, or 3; n is 0, 1, or 2; and the sum of m+n is 1, 2, or 3.

Example 29. The tetra-coordinated boronic acid-functionalized polymer molecule of example 28, wherein the fluoroboric acid group comprises a trifluoroboric acid group having the general formula —BF₃.

Example 30. The tetra-coordinated boronic acid-functionalized polymer molecule of example 28, wherein the fluoroboric acid group has the formula —BF₂OH.

Example 31. The tetra-coordinated boronic acid-functionalized polymer molecule of example 28, wherein the fluoroboric acid group has the formula —BF(OH)₂.

Example 32. The tetra-coordinated boronic acid-functionalized polymer molecule of any of examples 27-31, wherein the main chain comprises a repeating unit that includes a benzimidazole unit.

Example 33. The tetra-coordinated boronic acid-functionalized polymer molecule of example 32, wherein the boron atom is linked to a secondary amine of the benzimidazole unit by way of a linker.

Example 34. The tetra-coordinated boronic acid-functionalized polymer molecule of any of examples 27-31, wherein: the main chain comprises a repeating unit that includes an aromatic ring; and the boron atom is covalently bonded to the aromatic unit.

Example 35. The tetra-coordinated boronic acid-functionalized polymer molecule of example 34, wherein the main chain comprises polystyrene.

Example 36. The tetra-coordinated boronic acid-functionalized polymer molecule of any of examples 27-35, wherein the tetra-coordinated boronic acid group is linked, directly or indirectly, to the main chain by a sulfonamide link or a sulfone link.

Example 37. The tetra-coordinated boronic acid-functionalized polymer molecule of any of examples 27-36, wherein: the main chain comprises PTFE having a side chain; the side chain is a long-side chain, a mid-side chain, or a short-side chain; and the boron atom is covalently bonded to the side chain.

Example 38. The tetra-coordinated boronic acid-functionalized polymer molecule of any of examples 27-37, wherein X is a conjugate base of a Brønsted-Lowry acid.

Example 39. The tetra-coordinated boronic acid-functionalized polymer molecule of any of examples 27-38, wherein the Brønsted-Lowry acid comprises an alkylsulfonic acid, an arylsulfonic acid, an alkylarylsulfonic acid, sulfuric acid, a phosphoric acid, a phosphinic acid, a carboxylic acid, a phenol, or a derivative of any of the foregoing.

Example 40. A membrane electrode assembly comprising: a first catalyst layer; a second catalyst layer; and a proton exchange membrane positioned between the first catalyst layer and the second catalyst layer; wherein at least one of the first catalyst layer, second catalyst layer, and proton exchange membrane is formed of a polymer moleculre comprising a main chain and a tetra-coordinated boronic acid group linked to the main chain, the tetra-coordinated boronic acid group having the general formula —BFₘXₙ(OH)₍₃₋ₘ₋ₙ₎ where B has four covalent bonds and is covalently bonded to a polymer main chain, side chain, or side group; m and n are each independently 0, 1, 2, or 3; the sum of m+n is 1, 2, or 3; and X is an anion other than fluoride.

1. A method of making a tetra-coordinated boronic acid-functionalized polymer molecule, comprising:
reacting a pendant boronic acid group of a boronic acid-functionalized polymer molecule with a fluoride reagent and/or a compound having the general formula HX,
wherein HX is a Brønsted-Lowry acid.

2. The method of claim 1, wherein the boronic acid-functionalized polymer molecule comprises a boronic acid-functionalized polybenzimidazole (PBI) polymer molecule, a boronic acid-functionalized aromatic polymer molecule, a boronic acid-functionalized PTFE polymer molecule, a boronic acid-functionalized PCTFE polymer molecule, or a boronic acid-functionalized cellulose polymer molecule.

3-6. (canceled)

7. The method of claim 1, wherein:
the method comprises reacting the pendant boronic acid group with the fluoride reagent; and
the fluoride reagent comprises hydrogen fluoride (HF), lithium fluoride (LiF), sodium fluoride (NaF), potassium fluoride (KF), potassium bifluoride (KHF₂), cesium fluoride (CsF), ammonium fluoride (NH₄F), ammonium bifluoride (NH₄F₂), or a tetraalkylammonium fluoride having the general formula NR₄F, wherein each R is independently hydrogen or a substituted or unsubstituted alkyl or aryl group.

8. The method of claim 1, wherein:
the method comprises reacting the pendant boronic acid group with the fluoride reagent; and
the fluoride reagent comprises boron trifluoride.

9-13. (canceled)

14. The method of claim 1, further comprising making the boronic acid-functionalized polymer molecule,
wherein the making the boronic acid-functionalized polymer molecule comprises functionalizing a polymer molecule with a boronic acid group.

15. The method of claim 14, wherein the polymer molecule comprises a PBI polymer molecule, an aromatic polymer molecule, a PTFE polymer molecule, a sulfonic acid-functionalized polymer molecule, a boronic acid-functionalized PCTFE polymer molecule, or a cellulose polymer molecule.

16-20. (canceled)

21. The method of claim 14, wherein the functionalizing the polymer molecule with the boronic acid group comprises borylating an aromatic ring in a repeating unit of a main chain of the polymer molecule.

22. (canceled)

23. The method of claim 14, wherein the functionalizing the polymer molecule with the boronic acid group comprises linking a boronic acid functionalized linker with a secondary nitrogen in a repeating unit of a main chain of the polymer molecule.

24. The method of claim 23, wherein the secondary nitrogen is included in a benzimidazole unit of the main chain.

25. The method of claim 14, wherein the functionalizing the polymer molecule with the boronic acid group comprises:
activating a sulfonic acid group of a sulfonic acid-functionalized polymer molecule to a sulfonyl chloride, sulfonyl fluoride, or sulfonyl ester; and
linking an amino group of an amino boronic acid linker with the sulfonyl chloride, sulfonyl fluoride, or sulfonyl ester.

26. The method of claim 14, wherein the functionalizing the polymer molecule with the boronic acid group comprises:
activating a sulfonic acid group of a sulfonic acid-functionalized polymer molecule to a sulfonyl chloride, sulfonyl fluoride, or sulfonyl ester;
linking an aromatic boronic acid with the sulfonyl chloride, sulfonyl fluoride, or sulfonyl ester; and
protonating the aromatic boronic acid.

27. A tetra-coordinated boronic acid-functionalized polymer molecule comprising:
a main chain; and
a tetra-coordinated boronic acid group linked to the main chain by way of a secondary nitrogen atom or an aromatic group, the tetra-coordinated boronic acid group having the general formula —BFₘXₙ(OH)₍₃₋ₘ₋ₙ₎ where boron atom (B) has four covalent bonds and is covalently bonded to a polymer main chain, side chain, or side group; m and n are each independently 0, 1, 2, or 3; the sum of m+n is 1, 2, or 3; and X is an anion other than fluoride.

28. The tetra-coordinated boronic acid-functionalized polymer molecule of claim 27, wherein the tetra-coordinated boronic acid comprises a fluoroboric acid group where m is 1, 2, or 3; n is 0, 1, or 2; and the sum of m+n is 1, 2, or 3.

29-31. (canceled)

32. The tetra-coordinated boronic acid-functionalized polymer molecule of claim 27, wherein the main chain comprises a repeating unit that includes a benzimidazole unit.

33. The tetra-coordinated boronic acid-functionalized polymer molecule of claim 32, wherein the boron atom is linked to a secondary amine of the benzimidazole unit by way of a linker.

34. The tetra-coordinated boronic acid-functionalized polymer molecule of claim 27, wherein:
the main chain comprises a repeating unit that includes an aromatic ring; and
the boron atom is covalently bonded to the aromatic ring.

35. (canceled)

36. The tetra-coordinated boronic acid-functionalized polymer molecule of claim 27, wherein the tetra-coordinated boronic acid group is linked, directly or indirectly, to the main chain or a side chain by a sulfonamide link or a sulfone link.

37. The tetra-coordinated boronic acid-functionalized polymer molecule of claim 27, wherein:
the main chain comprises PTFE having a side chain;
the side chain is a long-side chain, a mid-side chain, or a short-side chain; and
the boron atom is covalently bonded to the side chain.

38. The tetra-coordinated boronic acid-functionalized polymer molecule of claim 27, wherein X is a conjugate base of a Brønsted-Lowry acid.

39. (canceled)

40. A membrane electrode assembly comprising:
a first catalyst layer;
a second catalyst layer; and
a proton exchange membrane positioned between the first catalyst layer and the second catalyst layer;
wherein at least one of the first catalyst layer, second catalyst layer, and proton exchange membrane is formed of a polymer molecule comprising a main chain and a tetra-coordinated boronic acid group linked to the main chain by way of a secondary nitrogen atom or an aromatic group, the tetra-coordinated boronic acid group having the general formula —BFₘXₙ(OH)₍₃₋ₘ₋ₙ₎ where B has four covalent bonds and is covalently bonded to a polymer main chain, side chain, or side group; m and n are each independently 0, 1, 2, or 3; the sum of m+n is 1, 2, or 3; and X is an anion other than fluoride.
